(19) United States
(12) Patent Application Publication
(10) Pub. No.: US 2021/0070573 A1
(43) Pub. Date: Mar. 11, 2021

(54) INSPECTION DEVICE, CONTROL METHOD, SHEET CONVEYOR, PRINTING APPARATUS, AND IMAGE READING APPARATUS

(71) Applicant: Konica Minolta, Inc., Tokyo (JP)

(72) Inventors: Akinori KIMATA, Toyokawa-shi (JP); Yukinobu IGUCHI, Hamamatsu-shi (JP); Satoru SASAKI, Toyokawa-shi (JP); Kenichi HAYASHI, Anjo-shi (JP); Shiro UMEDA, Toyokawa-shi (JP); Noriyuki JINBO, Hamamatsu-shi (JP)

(21) Appl. No.: 17/012,719

(22) Filed: Sep. 4, 2020

(30) Foreign Application Priority Data
Sep. 5, 2019 (JP) 2019-161668

(51) Int. Cl. B65H 7/12; G01N 29/07; G01N 29/44

(52) U.S. Cl. CPC B65H 7/125; G01N 29/07; B65H 2701/1916; G01N 2291/0237; G01N 29/4427

(57) ABSTRACT

Provided is an inspection device that performs inspection using ultrasonic waves transmitted on the basis of a burst signal including a plurality of pulses, the inspection device includes: a decider that decides the number of pulses included in the burst signal, or a burst cycle of the burst signal, on the basis of an atmospheric pressure at an installation position of the inspection device; a generator that repeatedly generates the burst signal including the decided number of pulses, or the burst signal having the decided burst cycle; a transmitter that transmits ultrasonic waves on the basis of the burst signal repeatedly generated; and a receiver that receives ultrasonic waves.

### CROSS REFERENCES TO RELATED APPLICATIONS

The present invention claims priority under 35 U.S.C. § 119 to Japanese Patent Application No. 2019-161668, filed on Sep. 5, 2019, the entire content of which is incorporated herein by reference.

### BACKGROUND

### Technological Field

The present disclosure relates to a technology for performing inspection using ultrasonic waves.

### Description of the Related Art

An image forming apparatus having the functions of a scanner, a copier, and the like includes an automatic document feeder for conveying document sheets to the scanner one by one, and a sheet feeder for supplying recording sheets to the image forming unit one by one.

According to JP 2006-298598 A, an ultrasonic wave transmitter and an ultrasonic wave receiver are disposed at opposite positions, with the conveyance path for conveying sheets being interposed in between. Ultrasonic waves transmitted from the ultrasonic wave transmitter propagates through a sheet, and are received by the ultrasonic wave receiver. When propagating through a sheet, ultrasonic waves attenuate depending on the thickness, the basis weight, and the like of the sheet. In a case where two overlapping sheets are conveyed (multiple conveyance), the reception intensity of the ultrasonic waves that have propagated through the two sheets and been received exhibits a greater attenuation than the reception intensity (detection threshold) of the ultrasonic waves that have propagated through one sheet and been received. Accordingly, multiple conveyance of sheets can be detected.

Regarding this aspect, it is known that, in a case where an ultrasonic wave transmitter is installed in an environment with low atmospheric pressure (for example, in a highland with a higher altitude than 2000 m), the reception intensity of ultrasonic waves to be received by an ultrasonic wave receiver is lower than that in an environment with 1 atmosphere (in a lowland with an altitude of approximately 0 to 10 m).

For this reason, even if the signal amplification factor of each product is adjusted in a lowland before shipment, the reception intensity of ultrasonic waves of a product installed in a highland becomes lower, resulting in a decrease in the accuracy of multiple conveyance detection.

To solve this problem, JP 2017-39589 A discloses a sheet feeder that includes an ultrasonic wave transmitter and an ultrasonic wave receiver. When the sheet feeding device is installed at a user's place, the service person sends a reference sheet onto the conveyance path, and measures the voltage level V0 of the ultrasonic reception signal. Further, the service person measures the voltage level V1 of the ultrasonic reception signal without sheet conveyance. The service person then calculates the ratio (V0/V1), and determines the threshold for detecting multiple conveyance from the calculated ratio. Thus, multiple conveyance of sheets can be accurately detected, regardless of the atmospheric pressure at the place where the sheet feeder is installed.

However, according to JP 2017-39589 A, the adjustment of the threshold using the reference sheet needs be performed at the site where the sheet feeder is installed, and therefore, adjustment work by the service person or the user is necessary.

The same problem as above might occur not only in a structure that detects multiple conveyance of sheets, but also in a device that inspects an organ of a human body or a structural object using ultrasonic waves.

### SUMMARY

The present disclosure aims to solve the above problem, and to provide an inspection device that is capable of performing inspection using ultrasonic waves without adjustment work using a reference sheet, regardless of the atmospheric pressure at the installation location, and also provide a control method, a sheet conveyor, a printing apparatus, and an image reading apparatus.

To achieve the abovementioned object, according to an aspect of the present invention, there is provided an inspection device that performs inspection using ultrasonic waves transmitted on the basis of a burst signal including a plurality of pulses, and the inspection device reflecting one aspect of the present invention comprises: a decider that decides the number of pulses included in the burst signal, or a burst cycle of the burst signal, on the basis of an atmospheric pressure at an installation position of the inspection device; a generator that repeatedly generates the burst signal including the decided number of pulses, or the burst signal having the decided burst cycle; a transmitter that transmits ultrasonic waves on the basis of the burst signal repeatedly generated; and a receiver that receives ultrasonic waves.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1A is a graph showing the relationship between altitude and atmospheric pressure (altitude-atmosphere characteristics);

FIG. 1B is a graph showing the relationship between atmospheric pressure and the output ratio of ultrasonic wave reception intensity;

FIG. 1C is a graph showing the relationship between the number of pulses included in a burst signal and ultrasonic wave reception intensity;

FIG. 2A to FIG. 2E show burst signals including five to nine pulses;

FIG. 3 shows the data structure of an atmospheric pressure pulse number table;

FIG. 4A is a diagram schematically showing the configuration of an image forming apparatus;

FIG. 4B shows an ultrasonic wave transmitter and an ultrasonic wave receiver that are arranged to face each other, with the conveyance path being interposed in between;

FIG. 5 is a block diagram showing the configuration of a control circuit;

FIG. 6 shows the data structure of an atmospheric pressure reference table;

FIG. 7 is a block diagram showing the configuration of an amplifier circuit;

FIG. 8A shows a pulse signal;

FIG. 8B shows a control signal;

FIG. 8C shows a burst signal including five pulses;

FIG. 8D shows a received signal;

FIG. 9 is a table showing output voltages as examples;

FIG. 10 is a flowchart showing an operation of the entire image forming apparatus;

FIG. 11 is a flowchart showing an atmospheric pressure acquiring operation;

FIG. 12 is a flowchart showing the operation in a pulse number deciding process;

FIG. 13 is a flowchart showing a multiple conveyance determining operation;

FIG. 14 shows output voltages under various conditions;

FIG. 15 shows the configuration of a second modification;

FIG. 16 shows the data structure of a burst cycle table in a third modification;

FIG. 17 is a flowchart showing operation of an image forming apparatus of the third modification;

FIG. 18 is a flowchart showing the operation in a burst cycle deciding process;

FIG. 19 is a flowchart showing a multiple conveyance determining operation;

FIG. 20 shows the data structure of a time difference table in a fourth modification;

FIG. 21 shows a burst signal 461 and a received signal;

FIG. 22 shows the configuration of an ultrasonic sensor of a fifth modification;

FIG. 23 shows the configuration of an ultrasonic sensor of a sixth modification; and

FIG. 24 shows a burst signal of a seventh modification.

### DETAILED DESCRIPTION OF EMBODIMENTS

Hereinafter, one or more embodiments of the present invention will be described with reference to the drawings. However, the scope of the invention is not limited to the disclosed embodiments.

### 1 Findings on which the Present Disclosure is Based

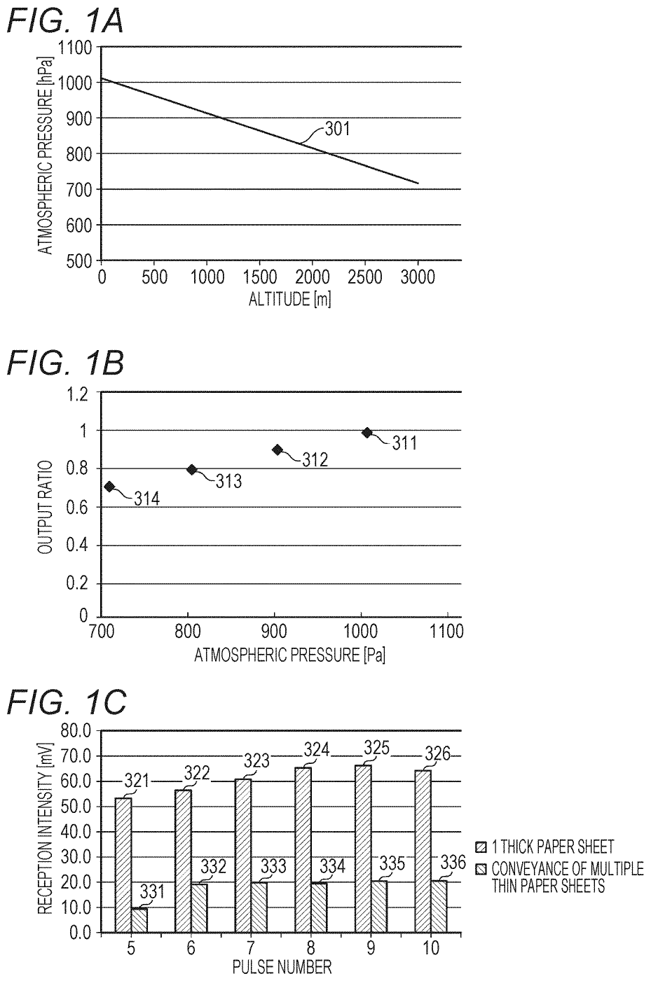

FIG. 1A shows the relationship between altitude above sea level and atmospheric pressure. In this graph, the abscissa axis indicates altitude [m], the ordinate axis indicates atmospheric pressure [hPa], and the relationship between altitude and atmospheric pressure is represented by a straight line 301. As shown in this graph, at an altitude of 0 m, the atmospheric pressure is 1013 hPa. At higher altitudes, the atmospheric pressure drops. At an altitude of 1000 m, the atmospheric pressure is about 900 hPa. At an altitude of 2000 m, the atmospheric pressure is about 800 hPa. At an altitude of 3000 m, the atmospheric pressure is about 700 hPa.

FIG. 1B shows the relationship between atmospheric pressure and the output ratio of the reception intensity of ultrasonic waves. An ultrasonic sensor formed with an ultrasonic wave transmitter and an ultrasonic wave receiver is installed in environments with the respective atmospheric pressures of 1013 hPa, 900 hPa, 800 hPa, and 700 hPa, and ultrasonic waves transmitted by the ultrasonic wave transmitter are received by the ultrasonic wave receiver so that the reception intensity thereof is measured. In this graph, the abscissa axis indicates atmospheric pressure [hPa], and the ordinate axis indicates the output ratio of the reception intensity measured in the environments with the respective atmospheric pressures in a case where the reception intensity measured in the environment with 1013 hPa (1 atmosphere) is “1”.

This graph shows points 311, 312, 313, and 314 that correspond to the respective atmospheric pressures of 1013 hPa, 900 hPa, 800 hPa, and 700 hPa, and indicate the output ratios of the reception intensities measured in the environments with the respective atmospheric pressures in a case where the reception intensity measured in the environment with 1013 hPa (1 atmosphere) is “1”.

The output ratios corresponding to the respective atmospheric pressures of 1013 hPa, 900 hPa, 800 hPa, and 700 hPa are “1”, “about 0.9”, “about 0.8”, and “about 0.7”, respectively. In this manner, the output ratio of reception intensity decreases with a decrease in atmospheric pressure.

As can be seen from FIG. 1B, the reception intensity of ultrasonic waves decreases as the atmospheric pressure drops in the environments in which the ultrasonic sensor is installed. Therefore, as a result of intensive studies, the researchers in the present disclosure have reached a method for preventing the reception intensity of ultrasonic waves from dropping even in a case where the atmospheric pressure drops in an environment in which an ultrasonic sensor is installed.

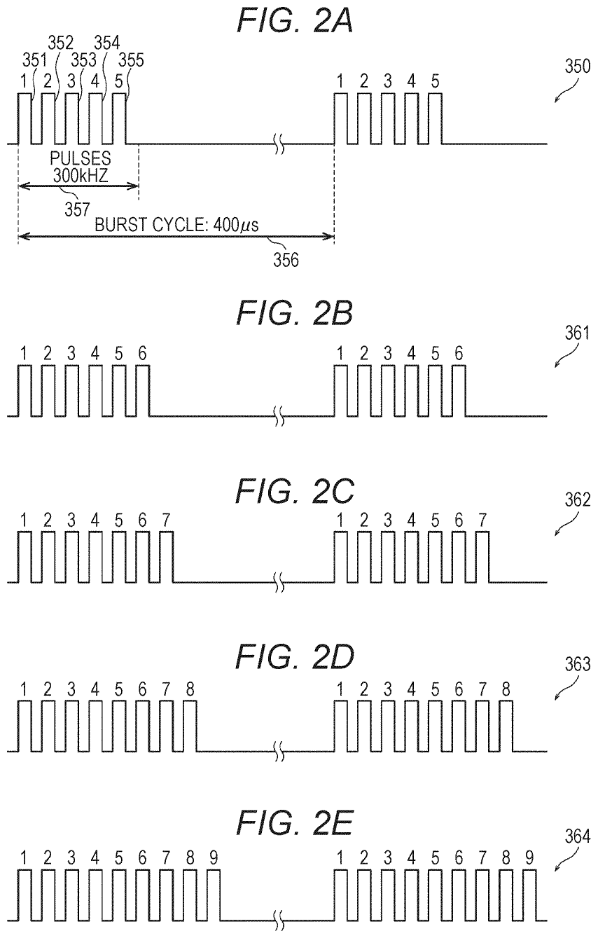

FIGS. 2A to 2E show the waveforms of burst signals including a plurality of pulses, which are the basis of generation of ultrasonic waves to be transmitted by the ultrasonic wave transmitter.

A burst signal 350 shown in FIG. 2A has burst cycles 356 with a time length of 400 μs, and includes the same signal repeatedly appearing in each burst cycle 356. Specifically, the burst signal 350 includes five pulses 351, 352, . . . , and 355 in the initial period 357 of each burst cycle. The five pulses 351, 352, . . . , and 355 oscillate at the same frequency (300 kHz).

Burst signals 361 to 364 shown in FIGS. 2B to 2E each have burst cycles with the same length as the burst cycles of the burst signal 350, and includes the same signal repeatedly appearing in each burst cycle.

The burst signal 361 shown in FIG. 2B includes six pulses in the initial period of each burst cycle. The six pulses oscillate at the same frequency (300 kHz).

The burst signal 362 shown in FIG. 2C includes seven pulses in the initial period of each burst cycle. The seven pulses oscillate at the same frequency (300 kHz).

Further, the burst signals 363 and 364 shown in FIGS. 2D and 2E include eight pulses and nine pulses, respectively, in the initial period of each burst cycle. The eight pulses of the burst signal 363 and the nine pulses of the burst signal 364 oscillate at the same frequency (300 kHz).

Although not shown in FIG. 2A to FIG. 2E, each burst signal may include a larger number of pulses in the initial period of each burst cycle. In this case, the pulses included in the burst signals also oscillate at the same frequency (300 kHz).

Upon receipt of the burst signals 350 and 361 to 364 shown in FIGS. 2A to 2E, the ultrasonic wave transmitter transmits ultrasonic waves of the same frequency, 300 kHz, for each burst signal. However, the burst signals 350 and 361 to 364 include different numbers of pulses. Therefore, the propagation energies of ultrasonic waves to be transmitted vary, and the reception intensities of ultrasonic waves to be received by the ultrasonic wave receiver vary.

The researchers in the present disclosure causes the ultrasonic wave transmitter to transmit ultrasonic waves using burst signals including different numbers of pulses (the numbers of the included pulses are “5”, “6”, “7”, “8”, “9”, and “10”) as described above, and caused the ultrasonic wave receiver facing the ultrasonic wave transmitter to receive the transmitted ultrasonic waves. Between the ultrasonic wave transmitter and the ultrasonic wave receiver, (a) one thick paper sheet or (b) two thin paper sheets (equivalent to a case where multiple conveyance is performed to convey two thin paper sheets) were placed.

The relationship between the numbers of pulses and the reception intensities obtained in this manner is shown in FIG. 1C. In this graph, the abscissa axis indicates the numbers of pulses included in the burst signals, and the ordinate axis indicates the reception intensities of ultrasonic waves.

In a case where a thick paper sheet is interposed between the ultrasonic wave transmitter and the ultrasonic wave receiver, the reception intensity of ultrasonic waves becomes higher as the number of pulses increases from “5” to “6” to “7” to “8” to “9”. When the number of pulses is increased from “9” to “10”, the reception intensity of ultrasonic waves becomes lower.

Further, in a case where two thin paper sheets are interposed between the ultrasonic wave transmitter and the ultrasonic wave receiver, the reception intensity of ultrasonic waves becomes higher as the number of pulses is increased from “5” to “6”. When the number of pulses is increased from “6” to “7” to “8” to “9” to “10”, the changes in the reception intensity of ultrasonic waves are small.

As can be seen from FIG. 1C, as the number of pulses increases, the reception output also increases (particularly, in the case of conveyance of a single thick paper sheet). This relationship changes depending on the characteristics of the ultrasonic sensor and the characteristics of the ultrasonic wave receiver circuit. In this embodiment, however, an increase of one pulse causes an approximately 7% increase in the output. The amplification factor per pulse varies depending on the characteristics of the ultrasonic sensor and the characteristics of the ultrasonic wave receiver circuit, and therefore, should be selected in accordance with the characteristics of the adopted system.

From the above results, the researchers in the present disclosure considered that it is possible to compensate for attenuation of the ultrasonic wave reception intensity at a low atmospheric pressure by changing the number of pulses included in a burst signal on which generation of ultrasonic waves is based, in accordance with the change in atmospheric pressure (or changes in altitude).

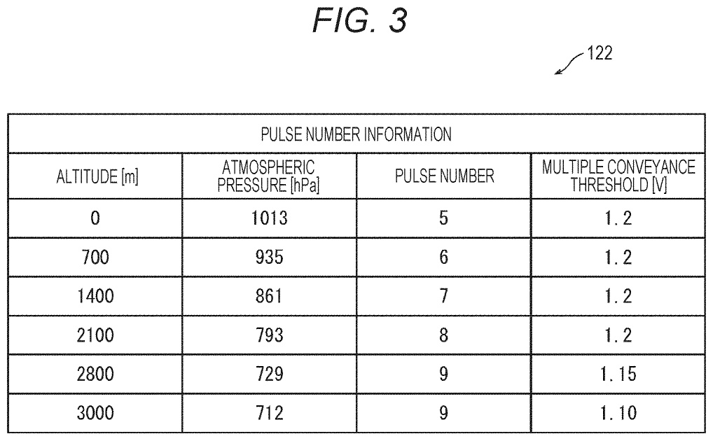

Therefore, the researchers in the present disclosure set the number of pulses included in a burst signal, in accordance with atmospheric pressure (or altitude), as shown in an atmospheric pressure pulse number table 122 (a pulse number table) in FIG. 3. This number of pulses is used for transmitting ultrasonic waves having propagation energy that depends on atmospheric pressure.

Specifically, the number of pulses included in a burst signal is set as “5”, “6”, “7”, “8”, “9”, and “9” for atmospheric pressures “1013”, “935”, “861”, “793”, “729”, and “712” [hPa], respectively (or for altitudes “0”, “700”, “1400”, “2100”, “2800”, and “3000” [m], respectively).

Here, as for the atmospheric pressures “1013” to “729”, the number of pulses becomes larger as the atmospheric pressure becomes lower. The atmospheric pressure pulse number table 122 includes a first combination of a first atmospheric pressure and a first pulse number, and a second combination of a second atmospheric pressure and a second pulse number. The first atmospheric pressure is higher than the second atmospheric pressure, and the first pulse number is smaller than the second pulse number.

The atmospheric pressure in an environment where the device is installed is acquired, the pulse number corresponding to the acquired atmospheric pressure is set in accordance with the atmospheric pressure pulse number table 122, and ultrasonic waves are transmitted by the ultrasonic wave transmitter using a burst signal including the set number of pulses. In this manner, it is possible to compensate for attenuation of the ultrasonic wave reception intensity by the increase in the number of pulses from that at standard atmospheric pressure, even in a case where the device is installed in an environment at a low atmospheric pressure.

Further, as shown in the atmospheric pressure pulse number table 122 (a threshold table), the researchers in the present disclosure set multiple conveyance thresholds “1.2”, “1.2”, “1.2”, “1.2”, “1.15”, and “1.10” [V] for determining whether two or more overlapping recording sheets are being conveyed, for atmospheric pressures “1013”, “935”, “861”, “793”, “729”, and “712” [hPa], respectively (or for altitudes “0”, “700”, “1400”, “2100”, “2800”, and “3000” [m], respectively).

That is, for each of the atmospheric pressures “1013”, “935”, “861”, and “793” [hPa], a multiple conveyance threshold “1.2” is set. In other words, different pulse numbers are set for the atmospheric pressures “1013”, “935”, “861”, and “793” [hPa], and it is possible to compensate for attenuation of ultrasonic wave reception intensity with the different pulse numbers. Therefore, the same multiple conveyance threshold is set for these atmospheric pressures.

Meanwhile, the same pulse number “9” is set for each of the atmospheric pressures “729” and “712” [hPa]. If the number of pulses is larger than 8, the effect to increase the output of the ultrasonic sensor will become smaller. This is particularly due to the influence of the piezoelectric ceramic of the ultrasonic sensor and its resonant characteristics. In this case, it is not possible to compensate for attenuation of the ultrasonic wave reception intensity by adjusting the number of pulses. Therefore, a change in the multiple conveyance threshold is also used in further increasing the output.

For example, when the altitude changes from 2,100 m to 2,800 m, the reception output of the receiver drops by about 7%. In a case where the lowest reception output of a non-multiple conveyance sheet is 1.5 V, the reception output drops by 1.5 V×7%=0.105 V, and the non-multiple conveyance sheet is likely to be wrongly detected as a multiple conveyance sheet. Therefore, the multiple conveyance threshold is lowered by 0.105 V×½≈0.05 V, to 1.2 V-0.05 V=1.15 V. Thus, the same margin is secured for non-multiple conveyance detection and multiple conveyance detection.

Specifically, at the atmospheric pressures “729” and “712” [hPa], the multiple conveyance thresholds are set to “1.15” and “1.10”, respectively, so that the multiple conveyance determination can be performed. As described above, in a case where an output decrease due to a decrease in atmospheric pressure cannot be compensated for with the number of transmitted pulses, the multiple conveyance threshold is lowered by the amount equivalent to the decrease in the reception intensity caused by the decrease in atmospheric pressure. Thus, the detection margin for multiple conveyance and non-multiple conveyance is optimized, and a decrease in accuracy of multiple conveyance determination is prevented.

As described above, the atmospheric pressure pulse number table 122 shown in FIG. 3 includes a plurality of pieces of pulse number information, and each piece of pulse number information includes an altitude, an atmospheric pressure, a pulse number, and a multiple conveyance threshold.

### 2 Embodiment

The following is a description of an embodiment according to the present disclosure, with reference to the accompanying drawings.

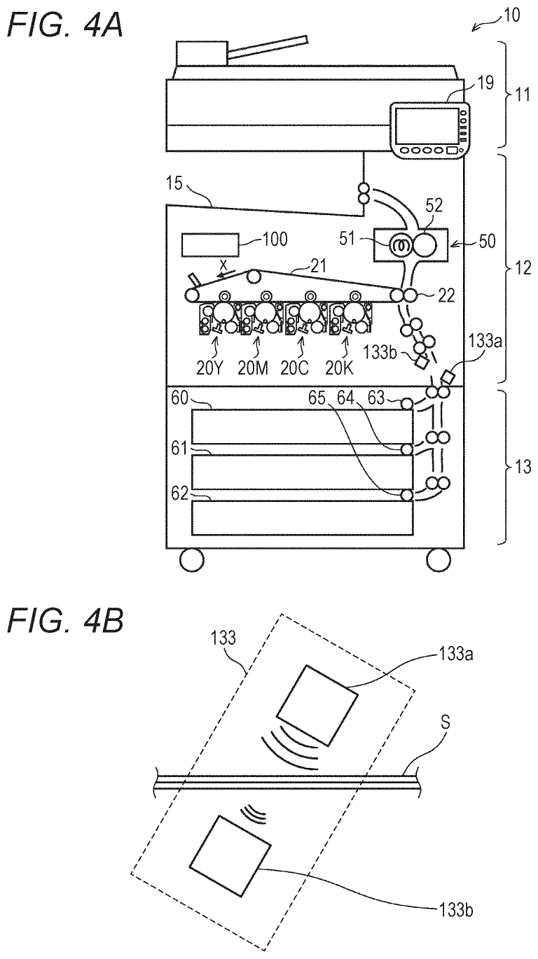

2.1 Image Forming Apparatus 10 As shown in FIG. 4A, an image forming apparatus 10 (a printing apparatus, or an image reading apparatus) is a tandem color multifunction peripheral (MFP) that has the functions of a scanner, a printer, and a copier.

As shown in this drawing, the image forming apparatus 10 has a sheet feeder unit 13 provided at the bottom portion of the housing. The sheet feeder unit 13 accommodates and feeds recording sheets. A printer 12 that forms an image by an electrophotographic technique is provided above the sheet feeder unit 13. Further, above the printer 12, an image reader 11 that reads a document and generates image data, and an operation panel 19 that displays an operation screen and receives an input operation from a user are provided.

The image reader 11 includes an automatic document feeder. The automatic document feeder conveys document sheets set on a document tray to a document glass plate one by one through a conveyance path. The image reader 11 moves a scanner, to read a document conveyed to a predetermined position on the document glass plate by the automatic document feeder, or an image placed on the document glass plate by a user. By doing so, the image reader 11 obtains image data formed with multilevel digital signals of red (R), green (G), and blue (B).

The image data of the respective color components obtained by the image reader 11 is then subjected to various kinds of data processing in a control circuit 100, and is further converted into image data of the respective reproduced colors of yellow (Y), magenta (M), cyan (C), and black (K).

The printer 12 includes: an intermediate transfer belt 21 that is stretched by a driving roller, a driven roller, and a backup roller; a secondary transfer roller 22; image forming units 20Y, 20M, 20C, and 20K that face the intermediate transfer belt 21 and are disposed at predetermined intervals in the traveling direction X of the intermediate transfer belt 21; a fixing unit 50; and the control circuit 100.

The image forming units 20Y, 20M, 20C, and 20K form toner images in the Y, M, C, and K colors, respectively. Specifically, each image forming unit includes a photosensitive drum that is an image carrier, an LED array for exposing and scanning the surface of the photosensitive drum, a charger, a developing device, a cleaner, and a primary transfer roller.

The sheet feeder unit 13 includes sheet feeder cassettes 60, 61, and 62 that accommodate recording sheets of different sizes, and pickup rollers 63, 64, and 65 for sending out the recording sheets from the sheet feeder cassettes to the conveyance path.

In each of the image forming units 20Y to 20K, the photosensitive drum is uniformly charged by the charger, and is exposed by the LED array, so that an electrostatic latent image is formed on the surface of the photosensitive drum. Each electrostatic latent image is developed by the developing device of the corresponding color, so that toner images in the Y to K colors are formed on the surfaces of the respective photosensitive drums. The toner images are then sequentially transferred onto the surface of the intermediate transfer belt 21 by electrostatic actions of the respective primary transfer rollers disposed on the back surface side of the intermediate transfer belt 21.

The image formation timing varies among the respective colors, so that the toner images in the Y to K colors are transferred in an overlapping manner onto the intermediate transfer belt 21.

Meanwhile, recording sheets are sent out from one of the sheet feeder cassettes of the sheet feeder unit 13, in accordance with image forming operations performed by the image forming units 20Y to 20K.

On the downstream side of the sheet feeder unit 13 in the direction of conveyance of recording sheets (inspection targets), an ultrasonic wave transmitter 133a (a transmitter) and an ultrasonic wave receiver 133b (a receiver) are disposed to face each other, with the conveyance path being interposed in between. As shown in FIG. 4B, the ultrasonic wave transmitter 133a and the ultrasonic wave receiver 133b constitute an ultrasonic sensor 133. The ultrasonic wave transmitter 133a is formed with piezoelectric ceramic or the like that is an ultrasonic wave oscillator. When the piezoelectric ceramic receives a burst signal that is AC waves, the piezoelectric ceramic repeatedly expands and contracts, and ultrasonic waves are transmitted by the expansion and contraction. In a case where a recording sheet S is being conveyed in the conveyance path, part of the transmitted ultrasonic waves passes through the recording sheet S. The ultrasonic waves having passed through the recording sheet S attenuate. Also, part of the transmitted ultrasonic waves is reflected by the surface of the recording sheet S. The ultrasonic wave receiver 133b is also formed with piezoelectric ceramic or the like that is an ultrasonic wave oscillator. Upon receipt of the ultrasonic waves having passed through the recording sheet S, the piezoelectric ceramic forming the ultrasonic wave receiver 133b repeats expansion and contraction, and generates a high-frequency voltage through the expansion and contraction. In this manner, the ultrasonic wave receiver 133b receives the ultrasonic waves transmitted by the ultrasonic wave transmitter 133a, and the control circuit 100 analyzes the received signal, so that multiple conveyance of recording sheets being conveyed in the conveyance path can be detected. In a case where multiple conveyance is detected, the image formation by the printer 12 is temporarily stopped, under the control of the control circuit 100. Here, the reception intensity of the ultrasonic waves received by the ultrasonic wave receiver 133b might include a noise-derived component, as well as the component derived from the ultrasonic waves transmitted by the ultrasonic wave transmitter 133a. This noise might be generated depending on the electromagnetic waves of the clutch of the image forming apparatus 10, the vibration from the drive unit, or the like, for example.

Referring back to FIG. 4A, in a case where multiple conveyance is not detected, the recording sheet S is conveyed in the conveyance path to the secondary transfer position at which the secondary transfer roller 22 and the backup roller face each other, with the intermediate transfer belt 21 being interposed in between. At the secondary transfer position, the toner images in the Y to K colors that have been transferred in an overlapping manner onto the intermediate transfer belt 21 are secondarily transferred onto the recording sheet S by an electrostatic action of the secondary transfer roller 22. The recording sheet S onto which the toner images in the Y to K colors have been secondarily transferred is further conveyed to the fixing unit 50.

Here, the conveyance path from the sheet feeder unit 13 to the secondary transfer position, the inspection device described later, and the multiple conveyance determining circuit 114 described later constitute a sheet conveyor that conveys sheets.

When the toner image on the surface of the recording sheet S passes through a fixing nip formed between a heating roller 51 of the fixing unit 50 and a pressure roller 52 pressed against the heating roller 51, the toner image is fused and fixed onto the surface of the recording sheet S by heat and pressure application. After passing through the fixing unit 50, the recording sheet S is sent out onto a sheet catch tray 15.

The operation panel 19 is equipped with a display unit formed with a liquid crystal display panel or the like, and displays the contents set by the user and various kinds of messages. The operation panel 19 receives a copy start instruction, a copy number setting, a copy condition setting, a data output destination setting, and the like from the user, and notifies the control circuit 100 of the received contents.

2.2 Control Circuit 100

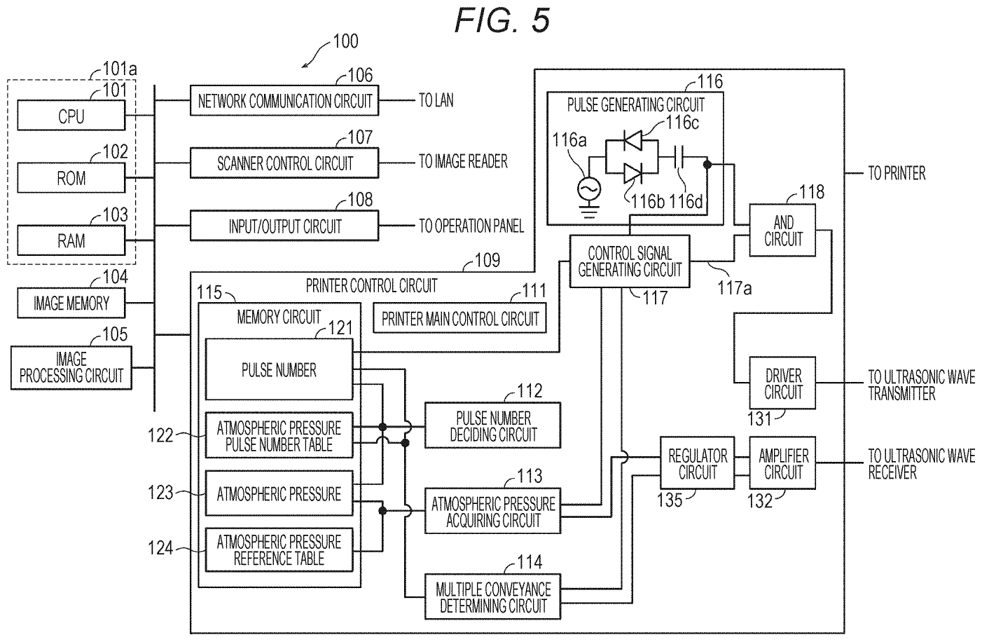

As shown in FIG. 5, the control circuit 100 includes a CPU 101, a ROM 102, a RAM 103, an image memory 104, an image processing circuit 105, a network communication circuit 106, a scanner control circuit 107, an input/output circuit 108, and a printer control circuit 109.

The CPU 101, the ROM 102, and the RAM 103 constitute a main control unit 101a.

The RAM 103 temporarily stores various control variables and the number of copies set through the operation panel 19, and also provides a work area when the CPU 101 executes a program.

The ROM 102 stores a control program and the like for executing various jobs such as a copy operation.

The CPU 101 operates according to the control program stored in the ROM 102.

As the CPU 101 operates according to the control program, the main control unit 101a comprehensively controls the image memory 104, the image processing circuit 105, the network communication circuit 106, the scanner control circuit 107, the input/output circuit 108, the printer control circuit 109, and the like.

After the power is turned on, the main control unit 101a determines whether it is the time to initialize the settings. Whether it is the time to initialize the settings depends on whether the image forming apparatus 10 is activated for the first time after shipment from the factory. In a case where it is the time to initialize the settings, the main control unit 101a causes the atmospheric pressure acquiring circuit 113 described later to acquire the atmospheric pressure, and causes the pulse number deciding circuit 112 described later to decide the number of pulses to be included in a burst signal of the ultrasonic sensor 133.

The main control unit 101a also receives a user operation from the operation panel 19. In a case where the user operation is a print instruction, the main control unit 101a causes the printer control circuit 109 to perform an image formation process. In a case where the user operation is some other instruction, the main control unit 101a causes the appropriate circuit to perform some other process.

The image memory 104 temporarily stores image data of a print job or the like.

The image processing circuit 105 performs various kinds of data processing on the image data of the R, G, and B color components obtained by the image reader 11, to convert the image data into image data of the respective reproduced colors of Y, M, C, and K, for example.

The network communication circuit 106 receives a print job from an external terminal device such as a personal computer (PC) via a network such as a LAN.

The scanner control circuit 107 controls the image reader 11 so that the image reader 11 performs an operation to read an image of a document.

The printer control circuit 109 will be described below.

2.3 Printer Control Circuit 109

As shown in FIG. 5, the printer control circuit 109 includes a printer main control circuit 111, a pulse number deciding circuit 112 (a decider), an atmospheric pressure acquiring circuit 113, a multiple conveyance determining circuit 114, a memory circuit 115, a pulse generating circuit 116, a control signal generating circuit 117, an AND circuit 118, a driver circuit 131, an amplifier circuit 132, and a regulator circuit 135.

During execution of an image formation process, the printer control circuit 109 causes the multiple conveyance determining circuit 114 to determine whether two or more overlapping sheets are being conveyed.

Here, the pulse number deciding circuit 112, the atmospheric pressure acquiring circuit 113, the memory circuit 115, the pulse generating circuit 116, the control signal generating circuit 117, the AND circuit 118, the driver circuit 131, the amplifier circuit 132, the regulator circuit 135, and the like constitute an inspection device that performs inspection using ultrasonic waves transmitted on the basis of a burst signal including a plurality of pulses.

Further, the pulse generating circuit 116, the control signal generating circuit 117, the AND circuit 118, the driver circuit 131, the amplifier circuit 132, the regulator circuit 135, and the like constitute a generator that generates a burst signal including a plurality of pulses.

(1) Printer Main Control Circuit 111

The printer main control circuit 111 comprehensively controls a sheet feeding operation of the sheet feeder unit 13 and image forming operations of the image forming units 20Y to 20K of the printer 12, so that an image forming operation is performed.

(2) Memory Circuit 115

The memory circuit 115 is formed with a nonvolatile semiconductor memory or the like, for example.

The memory circuit 115 stores the atmospheric pressure pulse number table 122 and an atmospheric pressure reference table 124 in advance. The memory circuit 115 also has a region for storing a pulse number 121 and an atmospheric pressure 123.

The atmospheric pressure pulse number table 122 is as described above.

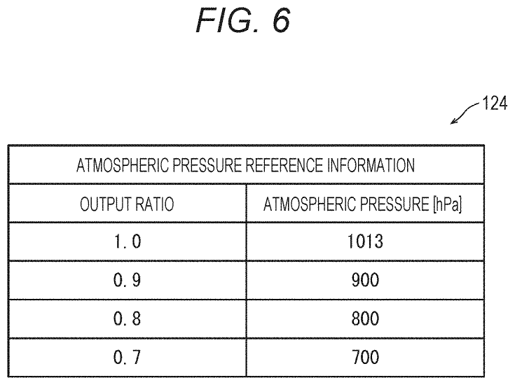

The atmospheric pressure reference table 124 is a data table that stores, as data, the relationship between atmospheric pressure and the output ratio of ultrasonic wave reception intensity shown in FIG. 1B. As shown in FIG. 6, the atmospheric pressure reference table 124 includes, as an example, a plurality of pieces of atmospheric pressure reference information, and each piece of atmospheric pressure reference information includes an output ratio and an atmospheric pressure. Here, the output ratio and the atmospheric pressure are as described above.

The atmospheric pressure reference table 124 is used for calculating the atmospheric pressure in the environment where the image forming apparatus 10 is installed, using the output ratio calculated from the reception intensity of ultrasonic waves received by the ultrasonic wave receiver 133b shown in FIG. 4B.

The pulse number 121 is the number of pulses included in a burst signal that is the basis of generation of ultrasonic waves to be transmitted by the ultrasonic wave transmitter 133a.

The atmospheric pressure 123 is the atmospheric pressure at the position where the image forming apparatus 10 is installed, and is a calculated atmospheric pressure.

(3) Pulse Generating Circuit 116

As shown in FIG. 5, the pulse generating circuit 116 includes two diodes 116b and 116c that are connected in parallel and are oriented in the forward direction and the reverse direction, and a capacitor 116d. The diodes 116b and 116c, and the capacitor 116d are connected in series to the output end of an AC power supply circuit 116a that outputs AC waves.

The pulse generating circuit 116 generates a pulse signal including repetitive pulses. Here, the frequency is 300 kHz, for example. The pulse generating circuit 116 outputs a pulse signal to the control signal generating circuit 117 and the AND circuit 118.

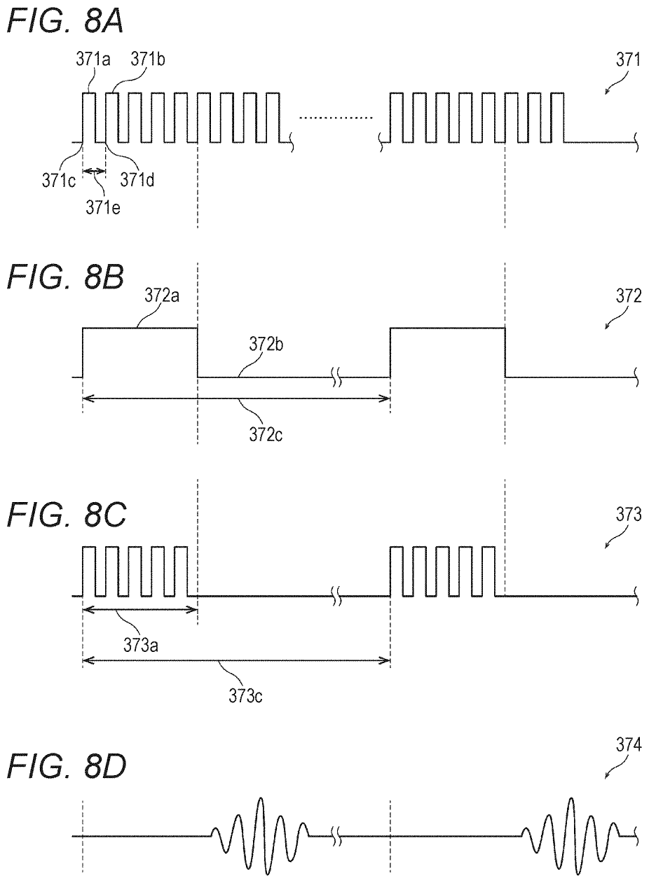

The waveform of a pulse signal 371 to be generated by the pulse generating circuit 116 is shown in FIG. 8A. In this graph, the time difference 371e between the rising time 371c at which a rectangular wave 371a switches from the Low level to the Hi level, and the rising time 371d at which a rectangular wave 371b following the rectangular wave 371a switches from the Low level to the Hi level is one pulse signal cycle.

(4) Control Signal Generating Circuit 117

The control signal generating circuit 117 receives the pulse number from the atmospheric pressure acquiring circuit 113, or reads the pulse number 121 from the memory circuit 115. The control signal generating circuit 117 also receives a pulse signal from the pulse generating circuit 116.

The control signal generating circuit 117 further generates a control signal that repeatedly switches between an ON signal and an OFF signal in cycles of the same length as the burst cycles of burst signals described above. Here, the control signal generating circuit 117 counts pulses, with the unit being a pulse signal cycle. In a case where the counted number of pulses is equal to or smaller than the received or read pulse number, the control signal generating circuit 117 outputs an ON signal during that period. On the other hand, in a case where the counted number of pulses is larger than the received or read pulse number, the control signal generating circuit 117 outputs an OFF signal during that period. Here, both the period during which an ON signal is output and the period during which an OFF signal is output are based on pulse signal cycles.

The waveform of a control signal 372 to be generated by the control signal generating circuit 117 is shown in FIG. 8B. In this graph, a cycle 372c of the same length as the burst cycles of burst signals described above is shown, and the control signal repeatedly switches between an ON signal 372a and an OFF signal 372b in the cycle 372c.

The control signal generating circuit 117 outputs the generated control signal from an output terminal 117a to the AND circuit 118.

(5) AND Circuit 118

The AND circuit 118 receives a pulse signal from the pulse generating circuit 116. The AND circuit 118 also receives a control signal from the control signal generating circuit 117.

The AND circuit 118 performs an AND operation on the received pulse signal and the received control signal, to generate a burst signal.

The waveform of a burst signal 373 to be generated by the AND circuit 118 is shown in FIG. 8C. In this graph, a burst cycle 373c of the burst signal 373 is shown. The burst signal 373 includes a plurality of pulses in the initial period 373a of the burst cycle 373c.

Here, the period 373a is based on pulse signal cycles.

The AND circuit 118 outputs the generated burst signal to the driver circuit 131.

(6) Driver Circuit 131

The driver circuit 131 receives a burst signal from the AND circuit 118. The driver circuit 131 generates a drive voltage from the burst signal, and outputs the generated drive voltage to the ultrasonic wave transmitter 133a.

(7) Amplifier Circuit 132 and Regulator Circuit 135

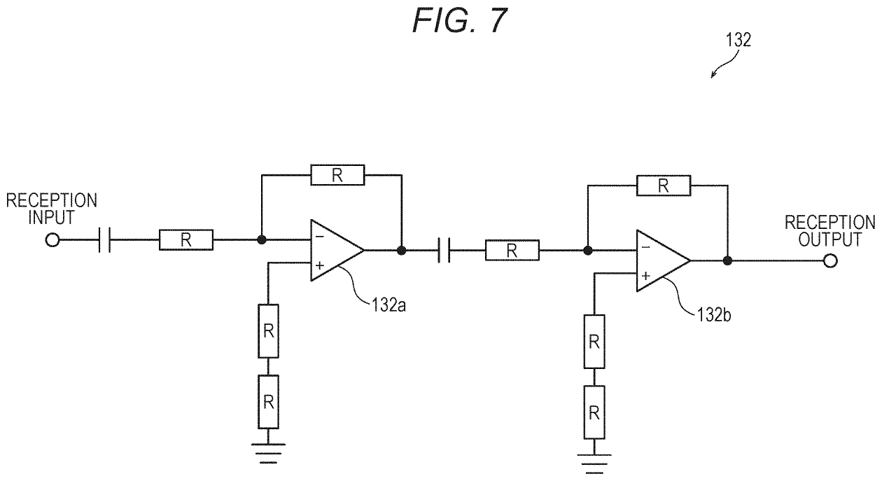

The amplifier circuit 132 receives a signal from the ultrasonic wave receiver 133b, and amplifies the received signal. As shown in FIG. 7, the amplifier circuit 132 includes amplifiers 132a and 132b, and other electrical elements. The amplifier 132a amplifies a signal received from the ultrasonic wave receiver 133b by a factor of 20, and outputs the amplified signal to the amplifier 132b. The amplifier 132b further amplifies the amplified signal received from the amplifier 132a by a factor of 20, and outputs the amplified signal.

The amplifier circuit 132 outputs the 400-fold amplified signal to the regulator circuit 135, for example.

The regulator circuit 135 limits the received signal to a minimum voltage of 0.5 V, for example, and a maximum voltage of 3.3 V, for example. The regulator circuit 135 outputs the regulated signal to the atmospheric pressure acquiring circuit 113 or the multiple conveyance determining circuit 114.

(8) Atmospheric Pressure Acquiring Circuit 113

The atmospheric pressure acquiring circuit 113 outputs a predetermined pulse number “5” to the control signal generating circuit 117.

The atmospheric pressure acquiring circuit 113 (a ratio calculator) receives a regulated signal from the regulator circuit 135, and calculates the intensity of the received signal (reception intensity). The atmospheric pressure acquiring circuit 113 then calculates the output ratio, using the reception intensity.

Output ratio=reception intensity/transmission intensity

Here, the transmission intensity is the intensity of the ultrasonic waves transmitted by the ultrasonic wave transmitter 133a on the basis of a burst signal including the predetermined “5” pulses. Accordingly, the transmission intensity is always a constant value.

The atmospheric pressure acquiring circuit 113 (an atmospheric pressure acquirer) then acquires the atmospheric pressure corresponding to the output ratio from the atmospheric pressure reference table 124, and writes the acquired atmospheric pressure as the atmospheric pressure 123 into the memory circuit 115.

(9) Pulse Number Deciding Circuit 112

The pulse number deciding circuit 112 reads the atmospheric pressure 123 from the memory circuit 115. The pulse number deciding circuit 112 then reads the pulse number corresponding to the read atmospheric pressure 123, from the atmospheric pressure pulse number table 122. The pulse number deciding circuit 112 then writes the read pulse number as the pulse number 121 into the memory circuit 115.

(10) Multiple Conveyance Determining Circuit 114

The multiple conveyance determining circuit 114 (a determiner) determines the state of a sheet being conveyed, using the reception intensity of received ultrasonic waves, as described below. Here, the multiple conveyance determining circuit 114 may compare the reception intensity and the multiple conveyance threshold, to determine whether the sheet is in an overlapping state. In a case where the reception intensity is lower than the multiple conveyance threshold, the multiple conveyance determining circuit 114 may determine that the sheet is in an overlapping state. Here, an overlapping state may be a state in which a plurality of overlapping sheets is being conveyed.

Here, the multiple conveyance threshold is decided on the basis of the component derived from ultrasonic waves transmitted by the ultrasonic wave transmitter 133a and the above described noise-derived component.

The multiple conveyance determining circuit 114 reads the pulse number 121 from the memory circuit 115. The multiple conveyance determining circuit 114 then outputs the read pulse number to the control signal generating circuit 117.

The multiple conveyance determining circuit 114 receives a regulated signal from the regulator circuit 135, and calculates the intensity of the received signal (reception intensity).

The multiple conveyance determining circuit 114 reads the atmospheric pressure 123 from the memory circuit 115, and reads the multiple conveyance threshold corresponding to the read atmospheric pressure 123 from the atmospheric pressure pulse number table 122 in the memory circuit 115. The multiple conveyance determining circuit 114 then compares the reception intensity with the multiple conveyance threshold. In a case where the reception intensity is lower than the multiple conveyance threshold, the multiple conveyance determining circuit 114 causes the printer main control circuit 111 to stop the recording sheet conveyance, and causes the main control unit 101a to control the operation panel 19 to display a message to the effect that overlapping recording sheets are being conveyed.

In a case where the reception intensity is equal to or higher than the multiple conveyance threshold, the multiple conveyance determining circuit 114 causes the printer main control circuit 111 to continue the image formation on the recording sheet.

2.4 Examples

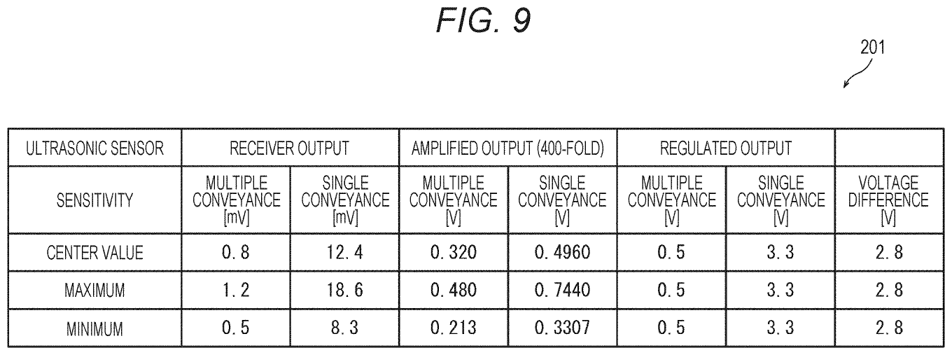

A table 201 in FIG. 9 shows the voltages output by the ultrasonic wave receiver 133b, the voltages output by the amplifier circuit 132, and the voltages output by the regulator circuit 135 in respective cases where three kinds of ultrasonic sensors with different sensitivities were used, and two or more recording sheets (multiple conveyance) or a single sheet (single conveyance) was conveyed.

Here, the three kinds of ultrasonic sensors with different sensitivities are an ultrasonic sensor with the center sensitivity, an ultrasonic sensor with the maximum sensitivity, and an ultrasonic sensor with the minimum sensitivity.

As shown in this table, in the case where the ultrasonic sensor with the center sensitivity was used, the voltage output by the ultrasonic wave receiver 133b, the voltage output by the amplifier circuit 132, and the voltage output by the regulator circuit 135 during multiple conveyance were 0.8 [mV], 0.32 [V], and 0.5 [V], respectively. The voltage output by the ultrasonic wave receiver 133b, the voltage output by the amplifier circuit 132, and the voltage output by the regulator circuit 135 during single conveyance were 12.4 [mV], 0.496 [V], and 3.3 [V], respectively. Here, the voltage difference between the single conveyance and the multiple conveyance was 2.8 [V].

Likewise, in the case where the ultrasonic sensor with the maximum sensitivity was used, the voltage difference between the single conveyance and the multiple conveyance was 2.8 [V]. Further, in the case where the ultrasonic sensor with the minimum sensitivity was used, the voltage difference between the single conveyance and the multiple conveyance was also 2.8 [V].

As described above, in this embodiment, voltage is regulated in the regulator circuit 135, so that a constant voltage is obtained during single conveyance and during multiple conveyance, regardless of the sensitivity of the ultrasonic sensor.

2.5 Operations in the Image Forming Apparatus 10

Operations in the image forming apparatus 10 are now described.

(1) Operation of the Entire Image Forming Apparatus 10

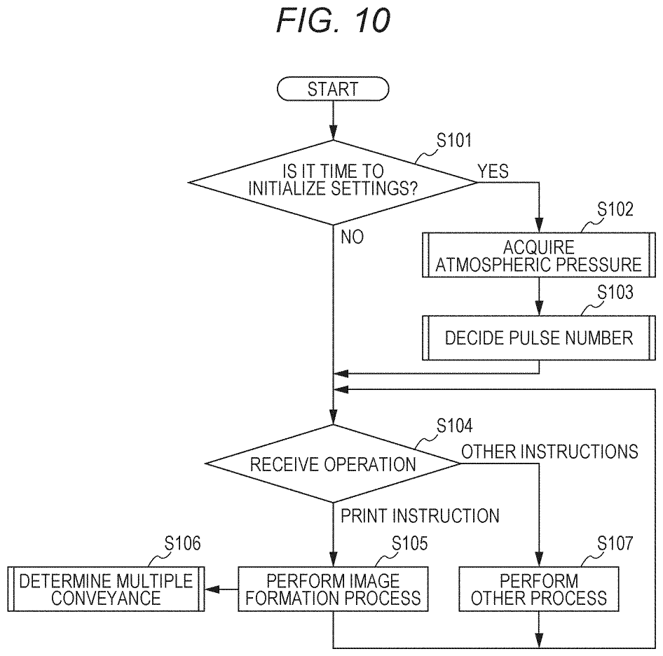

Referring now to a flowchart in FIG. 10, operation of the entire image forming apparatus 10 is described.

After the power is turned on, the main control unit 101a determines whether it is the time to initialize the settings (step S101). If it is the time to initialize the settings (“YES” in step S101), the main control unit 101a causes the atmospheric pressure acquiring circuit 113 to acquire the atmospheric pressure (step S102), and causes the pulse number deciding circuit 112 to decide the number of pulses to be included in a burst signal of the ultrasonic sensor 133 (step S103).

The main control unit 101a then receives a user operation from the operation panel 19 (step S104). If the user operation is a print instruction (“print instruction” in step S104), the main control unit 101a causes the printer control circuit 109 to perform an image formation process (step S105). During execution of the image formation process, the printer control circuit 109 causes the multiple conveyance determining circuit 114 to perform multiple conveyance determination (step S106). When the image formation process is completed, the main control unit 101a performs control to return to step S104.

If the user operation is some other instruction (“other instructions” in step S104), the main control unit 101a causes the appropriate circuit to perform some other process (step S107). When some other process is completed, the main control unit 101a performs control to return to step S104.

(2) Atmospheric Pressure Acquiring Operation

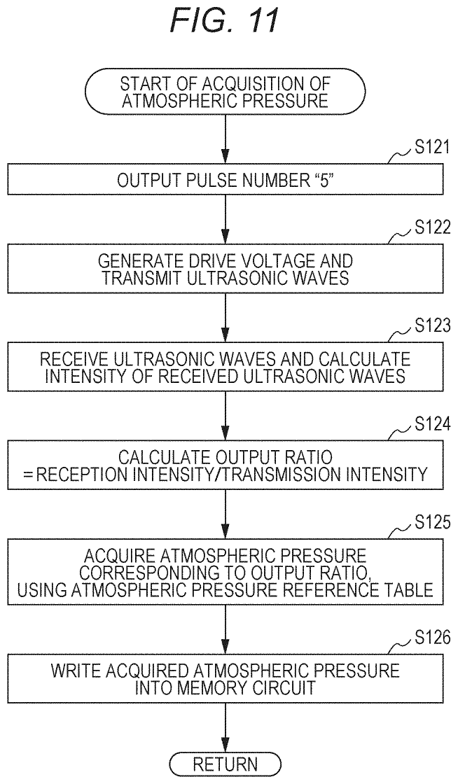

Referring now to a flowchart in FIG. 11, an atmospheric pressure acquiring operation is described. Step S102 in the flowchart in FIG. 10 is now described in detail as the atmospheric pressure acquiring operation.

The atmospheric pressure acquiring circuit 113 outputs a pulse number “5” to the control signal generating circuit 117 (step S121). The control signal generating circuit 117 generates a control signal from the pulse number “5”, and the AND circuit 118 performs an AND operation on the pulse signal and the control signal, to generate a burst signal. The AND circuit 118 outputs the burst signal to the driver circuit 131. The driver circuit 131 generates a drive voltage from the burst signal, and outputs the drive voltage to the ultrasonic wave transmitter 133a. The ultrasonic wave transmitter 133a transmits ultrasonic waves (step S122).

The ultrasonic wave receiver 133b receives the ultrasonic waves, and the amplifier circuit 132 amplifies the received signal. The regulator circuit 135 regulates the received signal. The atmospheric pressure acquiring circuit 113 receives the regulated signal from the regulator circuit 135, and calculates the intensity of the received signal (reception intensity) (step S123). The atmospheric pressure acquiring circuit 113 then calculates the output ratio=reception intensity/transmission intensity (step S124). The atmospheric pressure acquiring circuit 113 then acquires the atmospheric pressure corresponding to the output ratio, using the atmospheric pressure reference table 124 (step S125). The atmospheric pressure acquiring circuit 113 then writes the acquired atmospheric pressure as the atmospheric pressure 123 into the memory circuit 115 (step S126).

The description of the atmospheric pressure acquiring operation in the environment where the image forming apparatus 10 is installed now comes to an end.

(3) Operation in a Pulse Number Deciding Process

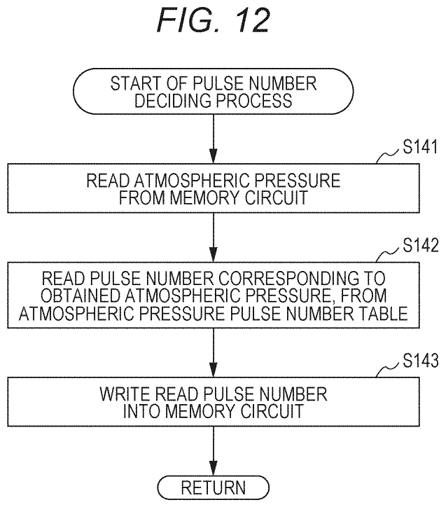

Referring now to a flowchart in FIG. 12, the operation in a pulse number deciding process is described. Step S103 in the flowchart in FIG. 10 is now described in detail as the pulse number deciding process.

The pulse number deciding circuit 112 reads the atmospheric pressure 123 from the memory circuit 115 (step S141). The pulse number deciding circuit 112 then reads the pulse number corresponding to the read atmospheric pressure 123, from the atmospheric pressure pulse number table 122 (step S142). The pulse number deciding circuit 112 then writes the read pulse number as the pulse number 121 into the memory circuit 115 (step S143).

The description of the operation in the pulse number deciding process now comes to an end.

(4) Multiple Conveyance Determining Operation

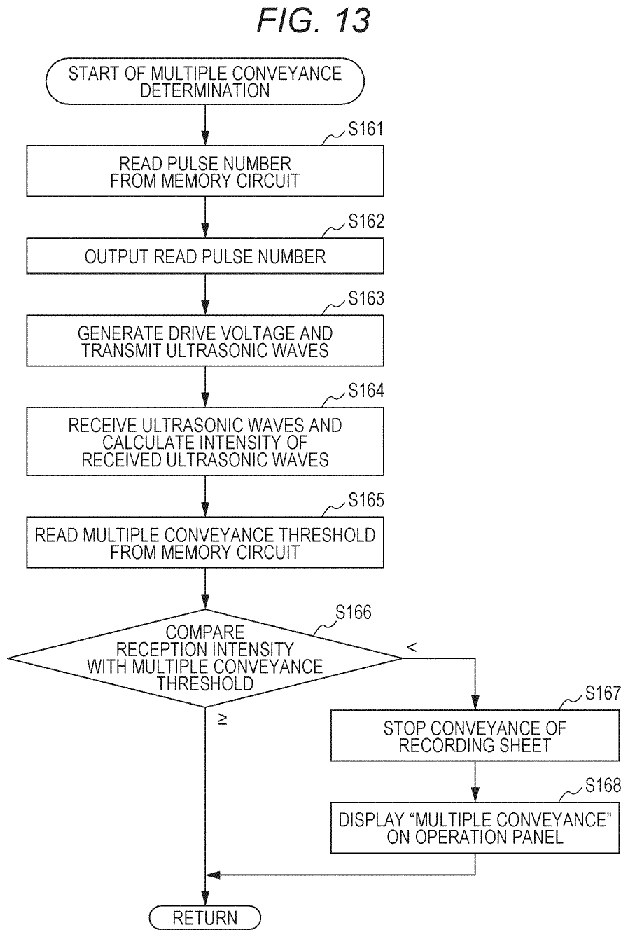

Referring now to a flowchart in FIG. 13, a multiple conveyance determining operation is described. Step S106 in the flowchart in FIG. 10 is now described in detail as the multiple conveyance determining operation.

The multiple conveyance determining circuit 114 reads the pulse number 121 from the memory circuit 115 (step S161). The multiple conveyance determining circuit 114 then outputs the read pulse number to the control signal generating circuit 117 (step S162). The control signal generating circuit 117 then generates a control signal from the received pulse number, and the AND circuit 118 performs an AND operation on the pulse signal and the control signal, to generate a burst signal. The AND circuit 118 outputs the burst signal to the driver circuit 131. The driver circuit 131 generates a drive voltage from the burst signal, and outputs the drive voltage to the ultrasonic wave transmitter 133a. The ultrasonic wave transmitter 133a transmits ultrasonic waves (step S163).

The ultrasonic wave receiver 133b receives the ultrasonic waves, and the amplifier circuit 132 amplifies the received signal.

The regulator circuit 135 regulates the received signal. The multiple conveyance determining circuit 114 receives the regulated signal from the regulator circuit 135, and calculates the intensity of the received signal (reception intensity) (step S164).

The multiple conveyance determining circuit 114 reads the atmospheric pressure 123 from the memory circuit 115, and reads the multiple conveyance threshold corresponding to the read atmospheric pressure 123 from the atmospheric pressure pulse number table 122 (step S165). The multiple conveyance determining circuit 114 then compares the reception intensity with the multiple conveyance threshold (step S166). If the reception intensity is lower than the multiple conveyance threshold (“<” in step S166), the multiple conveyance determining circuit 114 causes the printer main control circuit 111 to stop the recording sheet conveyance (step S167), and causes the main control unit 101a to control the operation panel 19 to display a message to the effect that overlapping recording sheets are being conveyed (step S168).

If the reception intensity is equal to the multiple conveyance threshold or where the reception intensity is higher than the multiple conveyance threshold (“>” in step S166), the printer main control circuit 111 continues the image formation, without stopping the recording sheet conveyance.

The description of the multiple conveyance determining operation now comes to an end.

2.6 Summary

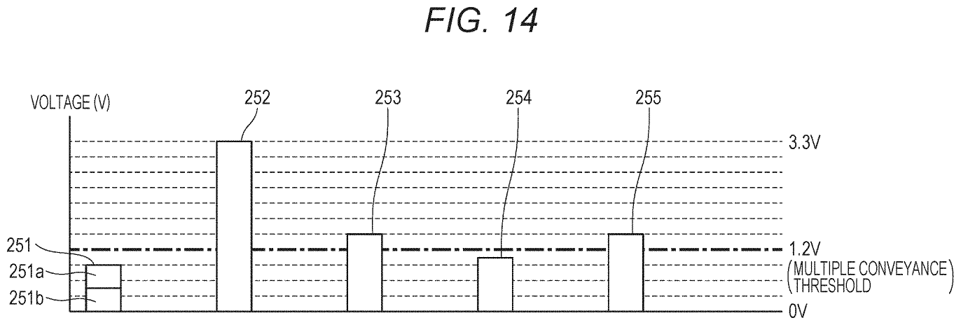

FIG. 14 shows the output voltages from the regulator circuit 135 under various conditions. In this graph, the ordinate axis indicates voltage.

An output voltage 251 indicates a case where two or more overlapping recording sheets were conveyed in multiple conveyance in a lowland (at an altitude of about 0 m to 10 m, for example). An output voltage 252 indicates a case where one plain paper sheet was conveyed in a lowland. An output voltage 253 indicates a case where one thick paper sheet was conveyed in a lowland. Meanwhile, an output voltage 254 indicates a case where one thick paper sheet was conveyed in a highland (at an altitude of 3000 m, for example), without any increase in the number of pulses. An output voltage 255 indicates a case where one thick paper sheet was conveyed in a highland, with an increase in the number of pulses.

The multiple conveyance threshold for determining whether multiple conveyance is being performed is 1.2V in these examples.

As shown in this graph, the output voltage 251 is formed with a voltage 251a and a voltage 251b. The voltage 251a depends on disturbance noise such as electromagnetic waves of a clutch of the image forming apparatus 10, vibration from the drive unit, or the like. The voltage 251b is due to multiple conveyance output, excluding the disturbance noise. Disturbance noise may or may not be generated depending on the operating state of the image forming apparatus 10. Disturbance noise is also added to the other output voltages 252 to 255.

In the case of a lowland, the output voltage 251 is lower than the multiple conveyance threshold, and therefore, the conveyance is correctly determined to be multiple conveyance. The output voltage 252 is higher than the multiple conveyance threshold, and therefore, the conveyance is correctly determined not to be multiple conveyance. Further, the output voltage 253 is higher than the multiple conveyance threshold, and therefore, the conveyance is correctly determined not to be multiple conveyance.

In the case of a highland, the output voltage 254 is lower than the multiple conveyance threshold, and therefore, the conveyance is wrongly determined to be multiple conveyance. On the other hand, the output voltage 255 is higher than the multiple conveyance threshold, and therefore, the conveyance is correctly determined to be multiple conveyance.

In this manner, the number of pulses is increased, and the ultrasonic wave propagation energy is increased in a highland, so that the output voltage can be regulated, and multiple conveyance can be correctly detected.

As described above, the number of pulses included in a burst signal is decided on the basis of the atmospheric pressure at the position where the image forming apparatus 10 is installed, and a burst signal including the determined number of pulses is generated. The ultrasonic wave transmitter causes the piezoelectric ceramic to vibrate in accordance with the pulses included in the generated burst signal, to emit ultrasonic waves. The ultrasonic wave receiver receives the ultrasonic waves.

With this configuration, it is possible to achieve the excellent effect to become able to perform inspection using ultrasonic waves without adjustment work using a reference sheet, regardless of the atmospheric pressure at the installation location.

Further, in an image forming apparatus, an error due to multiple conveyance often is often caused by deterioration of a pair of sheet feed rollers or the like. To detect multiple conveyance, simply detecting the thickness of the sheet is not enough. Normally, there is an air layer between sheets. If an ultrasonic sensor is used in such a situation, transmitted ultrasonic waves attenuate due to the presence of an air layer. Accordingly, with the use of an ultrasonic sensor, it is possible to determine multiple conveyance. However, if such a device is installed in a highland place, multiple conveyance cannot be determined. As a result, overlapping sheets are conveyed in multiple conveyance, which will cause fatal damage to the machine. Furthermore, it is very difficult to adjust the threshold for multiple conveyance in a highland. If the threshold is slightly changed, for example, non-multiple conveyance will be determined to be multiple conveyance. Therefore, even adjustment work using a reference sheet will be difficult. According to this embodiment, however, it is possible to correctly detect multiple conveyance, regardless of the atmospheric pressure at the installation location. The same applies to envelope detection. For envelope detection, an ultrasonic sensor is installed in the paper sheet conveyance path in many cases. The temperature of the fixing unit is then set at the temperature for envelopes, on the basis of the results of detection performed by the ultrasonic sensor. However, in a case where any envelope or the like is not detected, and the sheet is determined to be a plane paper sheet, a fixing temperature that is lower than that for envelopes is set, resulting in defective fixing. In that case, the fixing is insufficient. Therefore, there is a possibility that an unfixed image will be disturbed, or the inside of the apparatus will be contaminated. According to this embodiment, correct envelope detection can be performed, regardless of the atmospheric pressure at the installation location. Thus, defective fixing can be prevented in advance.

### 3 Modifications

The present disclosure has been described on the basis of the above embodiment, but is not limited to the embodiment. The embodiment may be modified as described below.

3.1 First Modification

In the image forming apparatus 10 according to the embodiment, the atmospheric pressure acquiring circuit 113 outputs a pulse number “5” to the control signal generating circuit 117, so that the ultrasonic wave transmitter 133a is made to transmit ultrasonic waves. The atmospheric pressure acquiring circuit 113 receives a signal that has been received by the ultrasonic wave receiver 133b and been amplified, calculates the reception intensity of the received signal, calculates the output ratio=reception intensity/transmission intensity, and acquires the atmospheric pressure corresponding to the output ratio from the atmospheric pressure reference table 124.

However, the present disclosure is not limited to this method.

An image forming apparatus as a first modification may include an atmospheric pressure measuring unit (atmospheric pressure measurer) that measures, with a pressure sensor, the atmospheric pressure in the environment where the image forming apparatus is installed, in addition to the components of the image forming apparatus 10 of the embodiment. The pulse number deciding circuit 112 in the image forming apparatus as the first modification may decide the number of pulses to be included in a burst signal, using the atmospheric pressure measured by the atmospheric pressure measuring unit.

As the image forming apparatus further includes the atmospheric pressure measuring unit designed for measuring atmospheric pressure as described above, it is possible to measure more accurately the atmospheric pressure in the environment where the image forming apparatus is installed.

3.2 Second Modification

A second modification of the embodiment is now described.

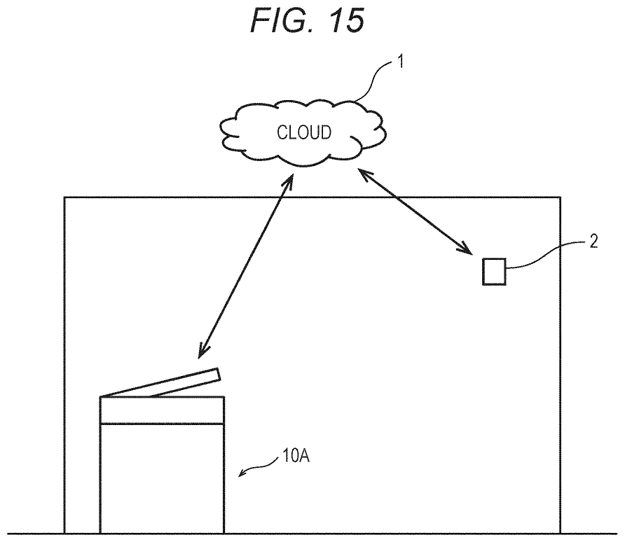

As shown in FIG. 15, in the second modification, an atmospheric pressure measuring unit 2 (an atmospheric pressure measurer) that measures atmospheric pressure with a pressure sensor is installed in an environment at the same atmospheric pressure as that in the environment where an image forming apparatus 10A having the same configuration as the image forming apparatus 10 of the embodiment is installed.

The atmospheric pressure measuring unit 2 is connected to a cloud 1 via a network. Further, the network communication circuit 106 (a communicator) in the image forming apparatus 10A is connected to the cloud 1 via the network.

The pulse number deciding circuit 112 in the image forming apparatus 10A may receive the measured atmospheric pressure from the atmospheric pressure measuring unit 2 via the cloud 1, and decide the number of pulses to be included in a burst signal, using the received atmospheric pressure.

As described above, information indicating atmospheric pressure is received, via the network, from the atmospheric pressure measuring unit designed for measuring atmospheric pressure. Accordingly, the image forming apparatus does not need to include an atmospheric pressure measuring unit. Thus, the costs for the image forming apparatus can be lowered, and the atmospheric pressure in the environment where the image forming apparatus is installed can be acquired more accurately.

3.3 Third Modification

A third modification of the embodiment is now described.

An image forming apparatus as the third modification has the same configuration as the image forming apparatus 10 of the embodiment. The differences from the image forming apparatus 10 of the embodiment are mainly described herein.

In the third modification, the burst cycle of burst signals is shortened so that the output energy per cycle can be increased. Accordingly, the burst cycle is shortened in accordance with a decrease in ultrasonic wave output due to a decrease in atmospheric pressure. The burst cycle is preferably 300 μs or longer, with the influence of reflected waves of ultrasonic waves and reverberation being taken into consideration. Therefore, in a case where the burst cycle is longer than 300 μs, the multiple conveyance threshold is also changed.

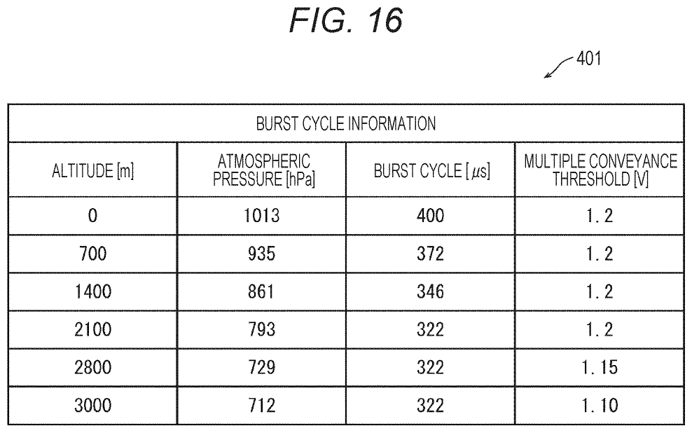

The memory circuit 115 in the image forming apparatus as the third modification may store a burst cycle table 401 shown in FIG. 16, instead of the atmospheric pressure pulse number table 122. Also, the image forming apparatus as the third modification may include a burst cycle deciding circuit (a decider), instead of the pulse number deciding circuit 112.

Further, the pulse generating circuit 116, the control signal generating circuit 117, the AND circuit 118, the driver circuit 131, the amplifier circuit 132, the regulator circuit 135, and the like constitute a generator that generates a burst signal that has a burst cycle determined as described later and includes a plurality of pulses.

(1) Burst Cycle Table 401

As shown in FIG. 16, the burst cycle table 401 includes a plurality of pieces of burst cycle information, and each piece of burst cycle information includes an altitude, an atmospheric pressure, a burst cycle, and a multiple conveyance threshold.

The altitudes, the atmospheric pressures, and the multiple conveyance thresholds are the same as the altitudes, the atmospheric pressures, and the multiple conveyance thresholds included in the atmospheric pressure pulse number table 122 shown in FIG. 3, and therefore, explanation of them is not made herein.

A burst cycle is the cycle of burst signals, as shown in FIG. 2A.

As shown in FIG. 16, in the burst cycle table 401, burst cycles “400”, “372”, “346”, “322”, “322”, and “322” [μs] are set for atmospheric pressures “1013”, “935”, “861”, “793”, “729”, and “712” [hPa], respectively (or for altitudes “0”, “700”, “1400”, “2100”, “2800”, and “3000” [m], respectively). These burst cycles are used for transmitting ultrasonic waves having propagation energy that depends on atmospheric pressure.

As described above, for the atmospheric pressures “1013” to “793” in the burst cycle table 401, shorter burst cycles are set for lower atmospheric pressures. Specifically, the burst cycle table 401 includes a first combination of a first atmospheric pressure and a first burst cycle, and a second combination of a second atmospheric pressure and a second burst cycle. The first atmospheric pressure is higher than the second atmospheric pressure, and the first burst cycle is longer than the second burst cycle.

Therefore, in accordance with the relationship between the atmospheric pressures and the burst cycles stored in the burst cycle table 401, the burst cycle corresponding to the atmospheric pressure at the position where the image forming apparatus is installed is selected, and a burst signal having the selected burst cycle is generated. Ultrasonic waves are then transmitted on the basis of the generated burst signal. In this manner, the ultrasonic wave transmission intensity can be increased in the entire zone corresponding a plurality of the burst cycles.

Accordingly, even in a case where the atmospheric pressure at the position where the image forming apparatus is installed is low, the ultrasonic wave transmission intensity can be increased.

As shown in the burst cycle table 401 in FIG. 16, the burst cycles “400”, “372”, “346” and “322” [μs] are set for the atmospheric pressures “1013”, “935”, “861”, and “793” [hPa], respectively. Meanwhile, the burst cycles “322” and “322” are set for the atmospheric pressures “729” and “712” [hPa], respectively. This is because it is possible to increase the ultrasonic wave transmission intensity by shortening the burst cycle in a case where the atmospheric pressure is within a certain range (atmospheric pressures of “1013” to “793” [hPa]), but it is not possible to increase the ultrasonic wave transmission intensity by shortening the burst cycle in a case where the atmospheric pressure is equal to or lower than a certain level (equal to or lower than the atmospheric pressure of “729” [hPa]).

Therefore, in a case where the atmospheric pressure is equal to or lower than the certain level (equal to or lower than the atmospheric pressure of “729” [hPa]), the multiple conveyance threshold is changed so that more accurate multiple conveyance determination can be performed.

(2) Burst Cycle Deciding Circuit

The burst cycle deciding circuit reads the atmospheric pressure 123 from the memory circuit 115. The burst cycle deciding circuit then reads the burst cycle corresponding to the read atmospheric pressure 123, from the burst cycle table 401. The burst cycle deciding circuit then writes the read burst cycle into the memory circuit 115.

(3) Multiple Conveyance Determining Circuit 114

The multiple conveyance determining circuit 114 reads the burst cycle from the memory circuit 115. The multiple conveyance determining circuit 114 then outputs the read burst cycle to the control signal generating circuit 117.

The multiple conveyance determining circuit 114 also reads the atmospheric pressure 123 from the memory circuit 115, and reads the multiple conveyance threshold corresponding to the read atmospheric pressure 123 from the burst cycle table 401 in the memory circuit 115. The multiple conveyance determining circuit 114 then compares the reception intensity with the multiple conveyance threshold. In a case where the reception intensity is lower than the multiple conveyance threshold, the multiple conveyance determining circuit 114 causes the printer main control circuit 111 to stop the recording sheet conveyance, and causes the main control unit 101a to control the operation panel 19 to display a message to the effect that overlapping recording sheets are being conveyed.

(4) Control Signal Generating Circuit 117

The control signal generating circuit 117 receives the burst cycle from the multiple conveyance determining circuit 114. The control signal generating circuit 117 also receives a pulse signal from the pulse generating circuit 116.

The control signal generating circuit 117 further generates a control signal that repeatedly switches between an ON signal and an OFF signal in cycles of the same length as the received burst cycle. Here, the control signal generating circuit 117 counts pulses. In a case where the counted number of pulses is equal to or smaller than a fixed pulse number “5”, the control signal generating circuit 117 outputs an ON signal during that period. On the other hand, in a case where the counted number of pulses is larger than the fixed pulse number “5”, the control signal generating circuit 117 outputs an OFF signal during that period.

The control signal generating circuit 117 outputs the generated control signal to the AND circuit 118.

(5) Operations in the Third Modification

Operations in the third modification are now described.

(a) Operation of the Entire Image Forming Apparatus

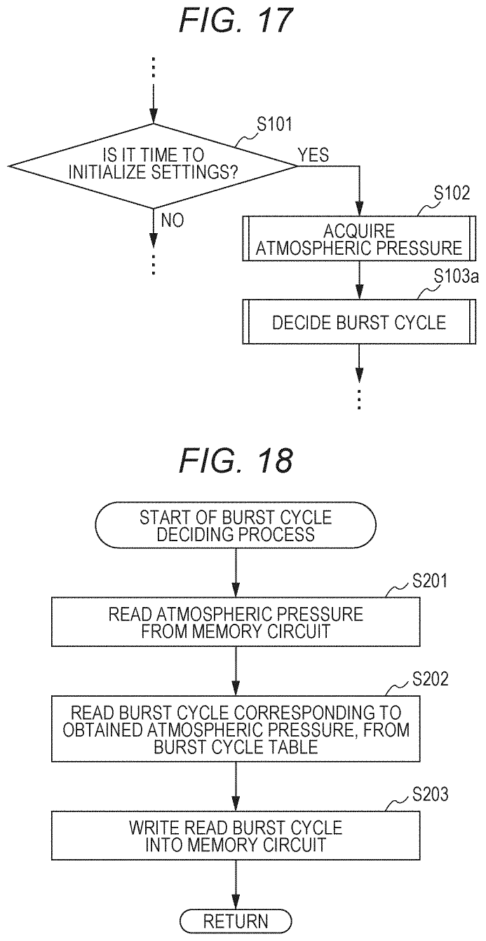

Operation of the entire image forming apparatus is almost the same as the operation of the image forming apparatus 10 of the embodiment shown in the flowchart in FIG. 10. In the third modification, however, a burst cycle is decided (step S103a) after atmospheric pressure acquisition (step S102), as shown in a flowchart in FIG. 17.

(b) Burst Cycle Deciding Operation

Referring now to a flowchart in FIG. 18, a burst cycle deciding operation is described. Step S103a in the flowchart in FIG. 17 is now described in detail as the burst cycle deciding operation.

The burst cycle deciding circuit reads the atmospheric pressure 123 from the memory circuit 115 (step S201). The burst cycle deciding circuit then reads the burst cycle corresponding to the read atmospheric pressure 123, from the burst cycle table 401 (step S202). The burst cycle deciding circuit then writes the read burst cycle into the memory circuit 115 (step S203).

The description of the burst cycle deciding operation now comes to an end.

(c) Multiple Conveyance Determining Operation

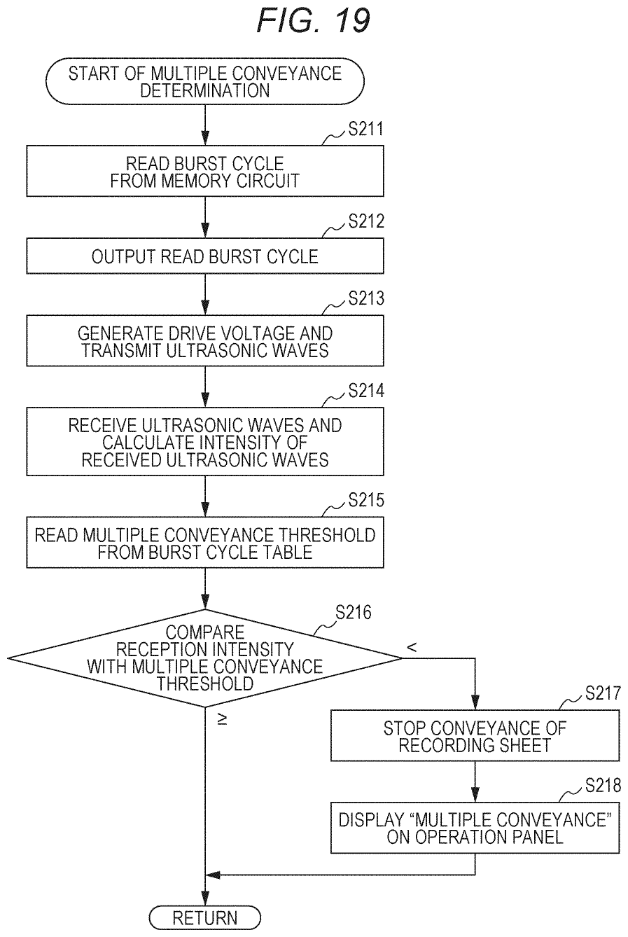

Referring now to a flowchart in FIG. 19, a multiple conveyance determining operation is described. Step S106 in the flowchart in FIG. 10 is now described in detail as the multiple conveyance determining operation.

The multiple conveyance determining circuit 114 reads the burst cycle from the memory circuit 115 (step S211). The multiple conveyance determining circuit 114 then outputs the read burst cycle to the control signal generating circuit 117 (step S212). The control signal generating circuit 117 then generates a control signal from the received burst cycle, and the AND circuit 118 performs an AND operation on the pulse signal and the control signal, to generate a burst signal. The AND circuit 118 outputs the burst signal to the driver circuit 131. The driver circuit 131 generates a drive voltage from the burst signal, and outputs the drive voltage to the ultrasonic wave transmitter 133a. The ultrasonic wave transmitter 133a transmits ultrasonic waves (step S213).

The ultrasonic wave receiver 133b receives the ultrasonic waves, and the amplifier circuit 132 amplifies the received signal. The regulator circuit 135 regulates the received signal. The multiple conveyance determining circuit 114 receives the regulated signal from the regulator circuit 135, and calculates the intensity of the received signal (reception intensity) (step S214).

The multiple conveyance determining circuit 114 reads the atmospheric pressure 123 from the memory circuit 115, and reads the multiple conveyance threshold corresponding to the read atmospheric pressure 123 from the burst cycle table 401 (step S215). The multiple conveyance determining circuit 114 then compares the reception intensity with the multiple conveyance threshold (step S216). If the reception intensity is lower than the multiple conveyance threshold (“<” in step S216), the multiple conveyance determining circuit 114 causes the printer main control circuit 111 to stop the recording sheet conveyance (step S217), and causes the main control unit 101a to control the operation panel 19 to display a message to the effect that overlapping recording sheets are being conveyed (step S218).

If the reception intensity is equal to the multiple conveyance threshold or where the reception intensity is higher than the multiple conveyance threshold (“>” in step S216), the printer main control circuit 111 continues the image formation, without stopping the recording sheet conveyance.

The description of the multiple conveyance determining operation now comes to an end.

(6) As described above, even in a case where the atmospheric pressure at the position where the image forming apparatus is installed is low, it is possible to increase the ultrasonic wave transmission intensity by selecting a short burst cycle in accordance with the atmospheric pressure.

3.4 Fourth Modification

A fourth modification of the embodiment is now described.

An image forming apparatus as the fourth modification has the same configuration as the image forming apparatus 10 of the embodiment. The differences from the image forming apparatus 10 of the embodiment are mainly described herein.

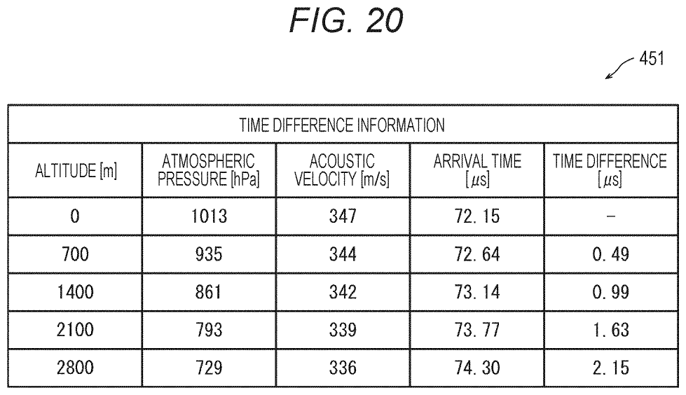

The velocity (acoustic velocity) of ultrasonic waves is fixed for each altitude (or each atmospheric pressure). The relationship between altitude and the acoustic velocity of ultrasonic waves is shown in a time difference table 451 (a propagation time table) in FIG. 20.

As shown in this table, the acoustic velocities of ultrasonic waves at altitudes “0”, “700”, “1400”, “2100” and “2800” [m] are “347”, “344”, “342”, “339” and “336” [m/s], respectively.

In the image forming apparatus of the fourth modification, this relationship is used in estimating the atmospheric pressure at the position where the image forming apparatus is installed, from the time difference between the time at which the ultrasonic wave transmitter 133a transmitted ultrasonic waves and the time at which the ultrasonic wave receiver 133b received the ultrasonic waves.

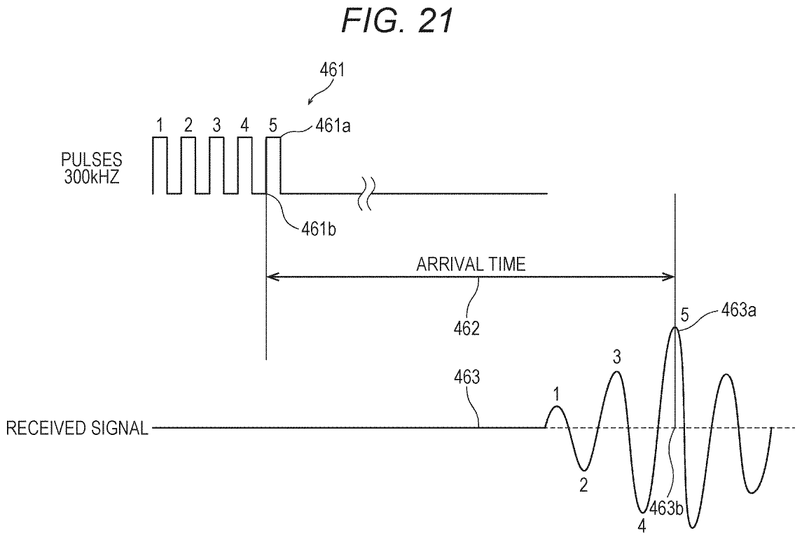

FIG. 21 shows a burst signal 461 that is the base for the ultrasonic wave transmitter 133a to transmit ultrasonic waves, and a received signal 463 that was received by the ultrasonic wave receiver 133b.

The burst signal 461 includes five pulses, and the rising time 461b of the fifth pulse 461a is the time at which ultrasonic waves were transmitted by the ultrasonic wave transmitter 133a.

Meanwhile, the waveform of the received signal 463 includes a plurality of peaks, and the time 463b at the largest peak 463a is the time at which the ultrasonic waves were received by the ultrasonic wave receiver 133b.

The time from the time 461b to the time 463b is the arrival time 462 (propagation time) of the ultrasonic waves from the ultrasonic wave transmitter 133a to the ultrasonic wave receiver 133b.

The time difference table 451 shown in FIG. 20 stores a plurality of pieces of time difference information. Each piece of time difference information includes an altitude [m], an atmospheric pressure [hPa], an acoustic velocity [m/s], an arrival time [μs], and a time difference [μs].

The altitudes [m], the atmospheric pressures [hPa], and the acoustic velocities [m/s] are as described above.

Each arrival time is the arrival time of ultrasonic waves from the ultrasonic wave transmitter 133a to the ultrasonic wave receiver 133b at the corresponding altitude (which is the corresponding atmospheric pressure). Here, the distance between the ultrasonic wave transmitter 133a and the ultrasonic wave receiver 133b is set at 25 mm, for example.

Here, the arrival time is calculated from the ratio between the distance from the ultrasonic wave transmitter 133a to the ultrasonic wave receiver 133b and the acoustic velocity of the ultrasonic waves. Since the distance and the acoustic velocity fluctuate depending on the temperature, the specific heat ratio, and the like, these fluctuating factors are taken into account in calculating the atmospheric pressure.

Each time difference indicates the time difference between each corresponding arrival time and a reference arrival time, with the reference being the arrival time (reference arrival time) in a case where the altitude is “0 m”.

The image forming apparatus of the fourth modification includes a time measurer (a timer), a peak value detector, a time difference calculator (a calculator), and an atmospheric pressure acquiring circuit (an atmospheric pressure acquirer).

The time measurer measures the time (transmission time) at which the ultrasonic wave transmitter 133a transmits ultrasonic waves, and writes the measured transmission time into the memory circuit 115.

The peak value detector detects the peak value of a signal received by the ultrasonic wave receiver 133b.

The time measurer measures the time (reception time) at which the peak value of the received signal is detected by the peak value detector, and writes the measured reception time into the memory circuit 115.

The time difference calculator calculates the time of arrival from the ultrasonic wave transmitter 133a to the ultrasonic wave receiver 133b, which is the time difference between the reception time and the transmission time. The time difference calculator then calculates the time difference between the calculated arrival time and the reference arrival time.

Time difference=calculated arrival time−reference arrival time

The atmospheric pressure acquiring circuit acquires, from the time difference table 451, the atmospheric pressure corresponding to the time difference calculated by the time difference calculator.

For example, in a case where the time difference is 1.63 μs, the altitude is estimated to be 2100 m, and the atmospheric pressure is estimated to be 793 hPa.

As described above, in the fourth modification, the atmospheric pressure at the position where the image forming apparatus is installed is acquired, on the basis of the time difference between the time at which the ultrasonic wave transmitter 133a transmitted ultrasonic waves and the time at which the ultrasonic wave receiver 133b received the ultrasonic waves.

In the fourth modification, the ultrasonic wave transmitter 133a and the ultrasonic wave receiver 133b are used in acquiring the atmospheric pressure. Accordingly, a special-purpose barometer for measuring atmospheric pressure is not necessary, and the costs for the image forming apparatus can be lowered.

In the fourth modification, an arrival time may be used in place of a time difference. That is, the atmospheric pressure acquiring circuit may acquire, from the time difference table 451, the atmospheric pressure corresponding to the arrival time calculated by the time difference calculator.

3.5 Fifth Modification

A fifth modification of the embodiment is now described.

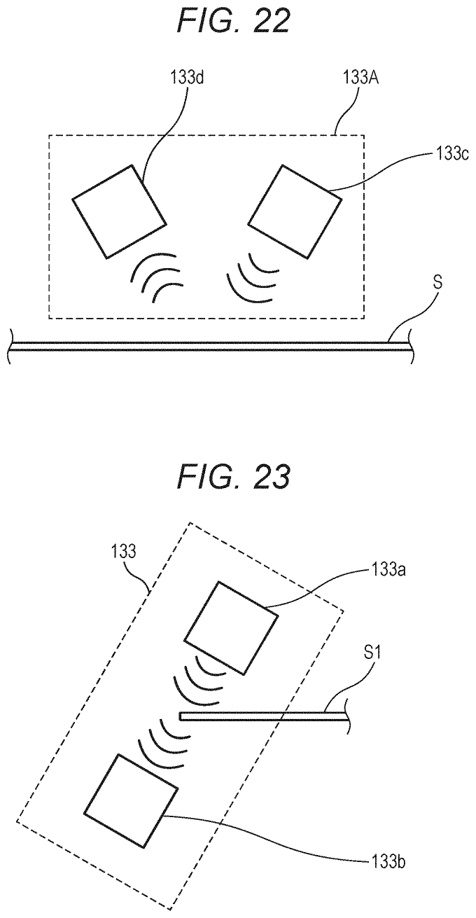

As shown in FIG. 22, in the fifth modification, an ultrasonic sensor 133A includes an ultrasonic wave transmitter 133c and an ultrasonic wave receiver 133d. The ultrasonic wave transmitter 133c and the ultrasonic wave receiver 133d are disposed on the same side when viewed from the conveyance path in which a recording sheet S (an inspection target) is being conveyed.

Ultrasonic waves transmitted by the ultrasonic wave transmitter 133c are reflected by the surface of the recording sheet S being conveyed in the conveyance path. The ultrasonic wave receiver 133d receives the ultrasonic waves reflected by the surface of the recording sheet S.

According to the fifth modification, the ultrasonic waves reflected by the surface of a recording sheet S are received, so that multiple conveyance can be performed as in the embodiment. Furthermore, in a case where there exist no recording sheets in the conveyance path, the ultrasonic wave receiver 133d does not receive ultrasonic waves. Accordingly, it is possible to determine that there exist no recording sheets in the conveyance path in the fifth modification.

3.6 Sixth Modification

A sixth modification of the embodiment is now described.

An image forming apparatus of the sixth modification has the same structure as the image forming apparatus 10 of the embodiment. Specifically, the ultrasonic sensor 133 includes the ultrasonic wave transmitter 133a and the ultrasonic wave receiver 133b, as shown in FIG. 23. The ultrasonic wave transmitter 133a and the ultrasonic wave receiver 133b are disposed on the opposite sides so as to face each other, with the conveyance path in which a recording sheet S is being conveyed being interposed between the ultrasonic wave transmitter 133a and the ultrasonic wave receiver 133b.

The image forming apparatus of the sixth modification further includes a top edge detecting circuit that detects the top edge of a recording sheet.

The top edge detecting circuit stores, beforehand, received signal levels to be observed in a case where there exist no recording sheets in the conveyance path.

In a case where a level to be observed when any recording sheet does not exist is being continuously detected, the top edge detecting circuit may determine that the top edge of a recording sheet has been detected when detecting a received signal with a lower intensity than the level to be observed when any recording sheet does not exist.

In the same manner as above, the top edge detecting circuit can also detect the bottom edge of a recording sheet.

In a case where a received signal with a lower intensity than a level to be observed when any recording sheet does not exist is being continuously detected, the top edge detecting circuit may determine that the bottom edge of a recording sheet has been detected when detecting the level to be observed when any recording sheet does not exist.

3.7 Seventh Modification

In the image forming apparatus 10 of the embodiment, the control signal generating circuit 117 regards both a period during which the ON signal 372a of the control signal 372 is output, and a period during which the OFF signal 372b of the control signal 372 is output, as one pulse signal cycle, as shown in FIG. 8B. However, the present disclosure is not limited to this.

In the seventh modification of the embodiment, the control signal generating circuit 117 may regard both a period during which the ON signal 372a of the control signal 372 shown in FIG. 8B is output, and a period during which the OFF signal 372b of the control signal 372 is output, as a half cycle that is a half of one pulse signal cycle.

Further, the image forming apparatus of the seventh modification may include a pulse generator that causes pulses to switch from the low level to the high level, or to switch from the high level to the low level, in each half cycle that is a half of one pulse cycle. By doing so, the pulse generator generates the plurality of pulses included in the burst signal.

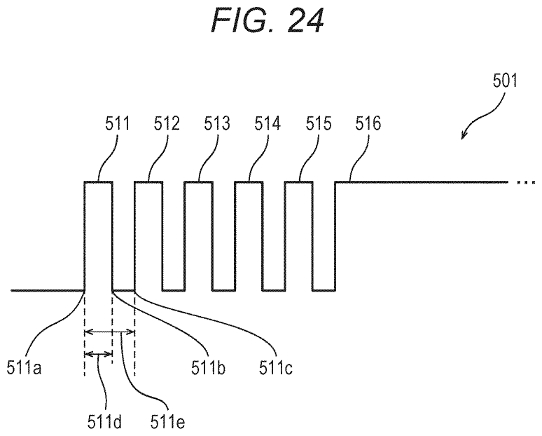

FIG. 24 shows a burst signal 501 to be generated by the image forming apparatus of the seventh modification.

The burst signal 501 includes pulses 511, 512, 513, 514, and 515 in this order, and also includes a rectangular wave 516 following the pulse 515.

Here, one pulse cycle is equal to the time difference 511e between the time 511a at which the initial pulse 511 switches from the low level to the high level, and the time 511c at which the pulse 512 following the initial pulse 511 switches from the low level to the high level. Further, a half cycle (a half of one cycle) is equal to the time difference 511d between the time 511a and the time 511b at which the pulse 511 switches from the high level to the low level.

Each of the pulses 511, 512, 513, 514, and 515 switches from the low level to the high level, or switches from the high level to the low level, in each half cycle. The rectangular wave 516 also switches from the low level to the high level in each half cycle.

As described above, each of the pulses included in the burst signal is made to switch from the low level to the high level, or from the high level to the low level, in each half cycle. Thus, pulses that switch levels in a shorter time can be generated.

3.8 Other Modifications

(1) In the embodiment and respective modifications described above, the image forming apparatus forms an image by an electrophotographic technique. However, the present disclosure is not limited to this. The image forming apparatus may be a printing apparatus that forms an image on a sheet by an inkjet technique.

(2) As described in the above embodiment, the image reader 11 (an image reading apparatus) includes an automatic document feeder. The automatic document feeder conveys document sheets set on a document tray to a document glass plate one by one through a conveyance path.

Here, the image reader 11 may include an ultrasonic wave transmitter and an ultrasonic wave receiver on both sides of the conveyance path. The image reader 11 may further include an inspection device that is the same as the inspection device described above. This inspection device may determine whether two or more document sheets are being conveyed when a document is conveyed from the automatic document feeder to the document glass plate.

(3) As described above, the multiple conveyance determining circuit 114 (a determiner) may compare a reception intensity and a threshold, to determine whether sheets are in an overlapping state. Here, an overlapping state may be a state in which an envelope is being conveyed.

(4) The inspection device of the present disclosure can be used in cases where various kinds of objects are inspected with ultrasonic waves, such as a case where organs or the like of human bodies or the like are inspected, a case where external defects and internal defects of structural objects or the like are inspected, a case where adhesion and peeling of metallic welds of metallic structural objects are inspected, a case where scratches in welds or the like are inspected, and a case where the thicknesses of structural objects or the like are measured.

(5) As described above, an inspection device, a sheet conveyor, a printing apparatus, an image forming apparatus, and an image reading apparatus are computer systems each including a microprocessor and a memory. The memory stores a computer program, and the microprocessor may operate according to the computer program.

The microprocessor includes a fetch unit, a decoding unit, an execution unit, a register file, and an instruction counter. The fetch unit reads, from the computer program stored in the memory, the respective instruction codes included in the computer program, one by one. The decoding unit decodes the read instruction codes. The execution unit operates in accordance with the results of the decoding. In this manner, the microprocessor operates according to the computer program stored in the memory.

Here, the computer program is created by combining instruction codes indicating instructions directed to a computer to achieve predetermined functions.

The computer program may be recorded in a computer-readable recording medium, such as a flexible disk, a hard disk, an optical disk, or a semiconductor, for example.

Alternatively, the computer program may be transmitted via a wired or wireless telecommunication line, a network such as the Internet, data broadcasting, or the like.

(6) The above embodiment and the above modifications may be combined in an appropriate manner.

The inspection device according to the present disclosure has an excellent effect to perform inspection using ultrasonic waves, regardless of the atmospheric pressure at the installation location, without any adjustment work using a reference sheet. Accordingly, the inspection device is useful as a technique for performing inspection using sound waves.

Although embodiments of the present invention have been described and illustrated in detail, the disclosed embodiments are made for purposes of illustration and example only and not limitation. The scope of the present invention should be interpreted by terms of the appended claims.

What is claimed is:

1. An inspection device that performs inspection using ultrasonic waves transmitted on the basis of a burst signal including a plurality of pulses, the inspection device comprising:
a decider that decides the number of pulses included in the burst signal, or a burst cycle of the burst signal, on the basis of an atmospheric pressure at an installation position of the inspection device;
a generator that repeatedly generates the burst signal including the decided number of pulses, or the burst signal having the decided burst cycle;
a transmitter that transmits ultrasonic waves on the basis of the burst signal repeatedly generated; and
a receiver that receives ultrasonic waves.

2. The inspection device according to claim 1, further comprising
a pulse number table that shows correspondence between atmospheric pressures and pulse numbers,
wherein, when deciding the number of pulses, the decider reads a pulse number corresponding to the atmospheric pressure at the installation position of the inspection device, from the pulse number table.

3. The inspection device according to claim 2, wherein
the pulse number table includes a first combination of a first atmospheric pressure and a first pulse number, and a second combination of a second atmospheric pressure and a second pulse number, and,
when the second atmospheric pressure is lower than the first atmospheric pressure, the second pulse number is larger than the first pulse number.

4. The inspection device according to claim 1, further comprising
a burst cycle table that shows correspondence between atmospheric pressures and burst cycles,
wherein, when deciding the burst cycle, the decider reads a burst cycle corresponding to the atmospheric pressure at the installation position of the inspection device, from the burst cycle table.

5. The inspection device according to claim 4, wherein
the burst cycle table includes a first combination of a first atmospheric pressure and a first burst cycle, and a second combination of a second atmospheric pressure and a second burst cycle, and,
when the second atmospheric pressure is lower than the first atmospheric pressure, the second burst cycle is shorter than the first burst cycle.

6. The inspection device according to claim 1, further comprising:
a timer that measures a transmission time at which ultrasonic waves are transmitted by the transmitter, and a reception time at which the transmitted ultrasonic waves are received by the receiver;
a calculator that calculates a propagation time of the ultrasonic waves, from a time difference between the reception time and the transmission time; and
an atmospheric pressure acquirer that acquires a value of the atmospheric pressure at the installation position of the inspection device, using the calculated propagation time,
wherein the decider decides the number of pulses or the burst cycle, using the value of the atmospheric pressure acquired by the atmospheric pressure acquirer.

7. The inspection device according to claim 6, further comprising
a propagation time table that shows correspondence between atmospheric pressures and propagation times,
wherein the atmospheric pressure acquirer acquires a value of an atmospheric pressure corresponding to the calculated propagation time, from the propagation time table.

8. The inspection device according to claim 1, further comprising:
an atmospheric pressure reference table that shows correspondence between transmission intensities of ultrasonic waves transmitted by the transmitter and reception intensities of ultrasonic waves received by the receiver;
a ratio calculator that calculates an output ratio between a transmission intensity of ultrasonic waves transmitted by the transmitter and a reception intensity of the ultrasonic waves received by the transmitter; and
an atmospheric pressure acquirer that reads a value of an atmospheric pressure corresponding to the calculated output ratio from the atmospheric pressure reference table, to acquire a value of the atmospheric pressure at the installation position of the inspection device,
wherein the decider decides the number of pulses or the burst cycle, using the value of the atmospheric pressure acquired by the atmospheric pressure acquirer.

9. The inspection device according to claim 1, further comprising
an atmospheric pressure measurer that measures an atmospheric pressure,
wherein the decider decides the number of pulses or the burst cycle, using a value of the atmospheric pressure measured by the atmospheric pressure measurer.

10. The inspection device according to claim 1, further comprising
a communicator that is installed in an area at the same atmospheric pressure as the atmospheric pressure at the installation position of the inspection device, and performs communication to acquire a value of a measured atmospheric pressure from an atmospheric pressure measurer that measures an atmospheric pressure,
wherein the decider decides the number of pulses or the burst cycle, using the value of the atmospheric pressure acquired by the communicator.

11. The inspection device according to claim 1, wherein
a time difference between a time at which an initial pulse switches from a low level to a high level and a time at which a pulse following the initial pulse switches from the low level to the high level is defined as one pulse cycle, a half of the one pulse cycle is defined as a half cycle, and
the inspection device further comprises
a pulse generator that causes a pulse to switch from the low level to the high level or from the high level to the low level in each half cycle, to generate the plurality of pulses included in the burst signal.

12. The inspection device according to claim 1, wherein
the transmitter and the receiver are positioned to face each other, with an inspection target being interposed in between,
ultrasonic waves transmitted by the transmitter pass through the inspection target, and
the receiver receives the ultrasonic waves that have passed through the inspection target.

13. The inspection device according to claim 1, wherein
the transmitter and the receiver are positioned on the same side of an inspection target,
ultrasonic waves transmitted by the transmitter are reflected by the inspection target, and
the receiver receives the ultrasonic waves reflected by the inspection target.

14. A sheet conveyor that conveys a sheet, the sheet conveyor comprising:
the inspection device according to claim 1; and
a determiner that determines a state of a sheet being conveyed, using a reception intensity of ultrasonic waves received by the receiver.

15. The sheet conveyor according to claim 14, wherein
the determiner compares the reception intensity with a threshold, to determine whether the sheet is in an overlapping state.

16. The sheet conveyor according to claim 15, wherein,
when the reception intensity is lower than the threshold, the determiner determines that the sheet is in an overlapping state.

17. The sheet conveyor according to claim 15, wherein
the overlapping state is a state in which a plurality of overlapping sheets is being conveyed, or a state in which an envelope is being conveyed.

18. The sheet conveyor according to claim 15, further comprising
a threshold table that includes a plurality of combinations of atmospheric pressures and thresholds corresponding to the atmospheric pressures,
wherein the determiner reads, from the threshold table, the threshold corresponding to the atmospheric pressure at the installation position of the inspection device, and uses the read threshold.

19. The sheet conveyor according to claim 15, wherein
the reception intensity of the ultrasonic waves received by the receiver includes a component derived from the ultrasonic waves transmitted by the transmitter and a noise-derived component, and
the threshold is decided on the basis of the component derived from the ultrasonic waves transmitted by the transmitter and the noise-derived component.

20. A control method that is used in an inspection device that performs inspection using ultrasonic waves transmitted on the basis of a burst signal including a plurality of pulses, the control method comprising:
deciding the number of pulses included in the burst signal, or a burst cycle of the burst signal, on the basis of an atmospheric pressure at an installation position of the inspection device; and
repeatedly generating the burst signal including the decided number of pulses, or the burst signal having the decided burst cycle,
wherein the inspection device includes: a transmitter that transmits ultrasonic waves on the basis of the burst signal repeatedly generated; and a receiver that receives ultrasonic waves.

21. A printing apparatus that forms an image on a sheet,
the printing apparatus comprising
the sheet conveyor according to claim 14.

22. An image reading apparatus that reads an image from an original,
the image reading apparatus comprising
the sheet conveyor according to claim 14.
